(19) United States
(12) Patent Application Publication
(10) Pub. No.: US 2025/0073788 A1
(43) Pub. Date: Mar. 6, 2025

(54) CONCEALED HINGE BORING JIG

(71) Applicant: KREG ENTERPRISES, INC., Ankeny, IA (US)

(72) Inventors: Jens Michael Pedersen, Des Moines, IA (US); Stacy Allan Peterson, Ames, IA (US); Ethan John Andersen, Bondurant, IA (US); Kyong S. Choi, Ames, IA (US); Nathan Joseph Hagarty, Cedar Rapids, IA (US); Zach Michael Scheuffele, Ames, IA (US); Brian William Hill, Ames, IA (US)

(21) Appl. No.: 18/816,402

(22) Filed: Aug. 27, 2024

Related U.S. Application Data
(60) Provisional application No. 63/579,101, filed on Aug. 28, 2023.

(51) Int. Cl. B23B 47/28

(52) U.S. Cl. CPC B23B 47/287; B23B 2247/00

(57) ABSTRACT

In one or more arrangements, a jig for cutting a pocket on a workpiece is presented, which has a base and a guide assembly. In one or more arrangements, the system includes a base having a bit aperture configured to allow a boring bit therethrough and a bit guide removably attached to the base. In one or more arrangements, the bit guide has a boring drill bit slidably located within a guide cylinder, a stop collar coupled to the boring bit, and a spring around the throat of the boring bit between a top spring surface of the guide cylinder and a bottom spring surface of the stop collar. In one or more arrangements, the spring is configured to urge the boring bit into a non-contact position with the workpiece.

### CROSS REFERENCE TO RELATED APPLICATIONS

This application claims priority to U.S. Provisional Application No. 63/579,101 filed Aug. 28, 2023 and titled CONCEALED HINGE BORING JIG, which is fully incorporated by reference herein.

### FIELD OF THE DISCLOSURE

This disclosure relates generally to wood working. More particularly, and without limitation, this disclosure relates to boring holes on a hinge face of a cabinet door for concealed hinge placement.

### OVERVIEW OF THE DISCLOSURE

A number of systems and devices have been developed for cutting or boring pockets on the back side or hinge side of wood and other materials. Each of these systems and devices have their own unique benefits as well as their own unique disadvantages and drawbacks.

Concealed hinge boring jigs include a base that rests on the back surface of a workpiece and includes a bit guide assembly to locate a boring bit on the workpiece. The boring bit (sometimes referred to as a forstner bit) cuts or bores out a hole (sometimes referred to as a “pocket hole”) on the back surface of the workpiece that does not extend through the workpiece to the front surface (also called the “class-A surface” of the workpiece). The bit guide assembly includes a stop collar coupled to the boring bit that sets the depth of the cut such that a concealed hinge sits flush with the back surface within the workpiece when assembled to the workpiece. While effective in many applications, these jigs suffer from many disadvantages.

Namely, boring bits (or “pocket hole bits”) typically include a center spur to locate and guide the bot in the proper location. The center spur extends downwardly from the chipper of the forstner bit and can be very sharp, leading to scratches on the workpiece when moving the jig from location to location. Another disadvantage is that it is difficult to locate the holes or bores uniformly from the top and the bottom of the workpiece. While the jig may include indicia to roughly locate the jig where desired from the top and bottom, there is some tolerance and/or error introduced when aligning the desired indicia with the top and bottom of the workpiece.

Another disadvantage of boring jigs is the number of steps between the pocket hole drilling and pilot hole drilling. The concealed hinges include holes for fasteners, typically wood screws, to hold the hinge in place within the bore. Some boring jigs may include pilot hole locators about the main boring bit aperture in the middle of the base. Because the same drill is typically used to drill out the concealed hinge bore and the pilot holes, the user generally removes the bit guide assembly from the base, then removes the boring bit from the drill, attaches the pilot hole bit back into the drill, drills the pilot holes, takes out the pilot hole bit, and reattaches the boring bit to the drill before moving the base to another location to ensure the pilot holes are drilled in the proper location.

After drilling the pilot holes, the user removes clamps from the base and sets them aside, removes the pilot hole bit from the drill, reattaches the boring bit, reattaches the bit guide assembly, relocates the jig in another location, grabs and reattaches the clamps to the base and workpiece and begins the boring process again. All of these steps are repeated as necessary, adding unproductive time to the process.

Another disadvantage of boring jigs is that the pilot hole locators are static and unmovable. The pilot hole locators are typically molded or dilled into the base from the manufacturer. Because of this, the base may not be usable to drill the pilot holes for all hinge types available to users.

As such, the prior art cutting systems suffer from many substantial disadvantages including: being hard on workpiece surfaces, hard to use, they have limited accuracy, and they can be tedious for big jobs among many other disadvantages.

Therefore, for all the reasons stated above, and the reasons stated below, there is a need in the art for an improved concealed hinge boring system that provides functionalities and capabilities never before present in a system.

Thus, it is a primary object of the disclosure to provide a concealed hinge boring system that improves upon the state of the art.

Another object of the disclosure is to provide a concealed hinge boring system that is safe to use.

Yet another object of the disclosure is to provide a concealed hinge boring system that is efficient to use.

Another object of the disclosure is to provide a concealed hinge boring system that is relatively inexpensive.

Yet another object of the disclosure is to provide a concealed hinge boring system that is capable of repeatably located holes.

Another object of the disclosure is to a concealed hinge boring system that is accurate.

Another object of the disclosure is to provide a concealed hinge boring system that provides precise alignment for a boring tool.

Yet another object of the disclosure is to provide a concealed hinge boring system that can be used with workpieces with a wide range of thicknesses.

Another object of the disclosure is to provide a concealed hinge boring system that can be used with workpieces with a wide range of lengths.

Yet another object of the disclosure is to provide a concealed hinge boring system that can be used with workpieces with a wide range of widths.

Another object of the disclosure is to provide a concealed hinge boring system that is unique.

Yet another object of the disclosure is to provide a concealed hinge boring system that is easy to learn how to use.

Another object of the disclosure is to provide a concealed hinge boring system that is relatively compact in size and shape.

Another object of the disclosure is to provide a concealed hinge boring system that holds the jig to the workpiece in a firm and rigid manner.

Yet another object of the disclosure is to provide a concealed hinge boring system that is easy to set up.

Another object of the disclosure is to provide a concealed hinge boring system that is easy to take down.

Yet another object of the disclosure is to provide a concealed hinge boring system that is easy to precisely adjust.

Yet another object of the disclosure is to provide a concealed hinge boring system that is formed of a minimum number of parts.

Another object of the disclosure is to provide a concealed hinge boring system that is simple to use.

Yet another object of the disclosure is to provide a concealed hinge boring system that is easier to use than prior art systems.

Another object of the disclosure is to provide a concealed hinge boring system that is more repeatable to use than prior art systems.

Yet another object of the disclosure is to provide a concealed hinge boring system that provides new capabilities to existing tools.

Another object of the disclosure is to provide a concealed hinge boring system that has a robust design.

Yet another object of the disclosure is to provide a concealed hinge boring system that is high quality.

Another object of the disclosure is to provide a concealed hinge boring system that is durable.

Yet another object of the disclosure is to provide a concealed hinge boring system that has a long useful life.

Another object of the disclosure is to provide a concealed hinge boring system that provides accurate and clean cuts.

Yet another object of the disclosure is to provide a concealed hinge boring system that saves time.

Another object of the disclosure is to provide a concealed hinge boring system that is fun to use.

Yet another object of the disclosure is to provide a concealed hinge boring system that can be used with workpieces of practically any material.

Another object of the disclosure is to provide a concealed hinge boring system that is easily portable and can be used on a job site.

Yet another object of the disclosure is to provide a concealed hinge boring system that makes it easier to measure bores.

Another object of the disclosure is to provide a concealed hinge boring system that makes measuring more repeatable than prior art systems.

Another object of the disclosure is to provide a concealed hinge boring system that prevents scratches and other marks on the workpiece.

Another object of the disclosure is to provide a concealed hinge boring system that is adaptable to many different hinge types.

These and other objects, features, or advantages of the disclosure will become apparent from the specification, figures, and claims.

### SUMMARY OF THE DISCLOSURE

In one or more arrangements, a jig for cutting a pocket on a workpiece is presented, which has a base and a guide assembly. In one or more arrangements, the system includes a base having a bit aperture configured to allow a boring bit therethrough and a bit guide removably attached to the base. In one or more arrangements, the bit guide has a boring drill bit slidably located within a guide cylinder, a stop collar coupled to the boring bit, and a spring around the throat of the boring bit between a top spring surface of the guide cylinder and a bottom spring surface of the stop collar. In one or more arrangements, the spring is configured to urge the boring bit into a non-contact position with the workpiece.

### BRIEF DESCRIPTION OF THE FIGURES

FIG. 1 shows an upper rear right perspective view of a system for drilling concealed hinge pocket holes, in accordance with one or more arrangements; the view showing the system clamped to a workpiece for drilling a concealed hinge pocket hole therein.

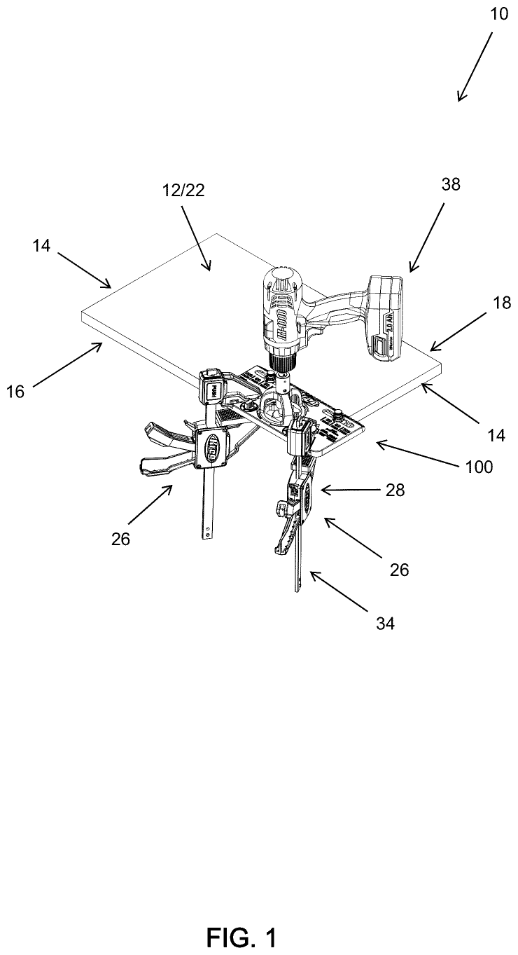

FIG. 2 shows a rear view of a system for drilling concealed hinge pocket holes, in accordance with one or more arrangements; the view showing the system clamped to a workpiece for drilling a concealed hinge pocket hole therein.

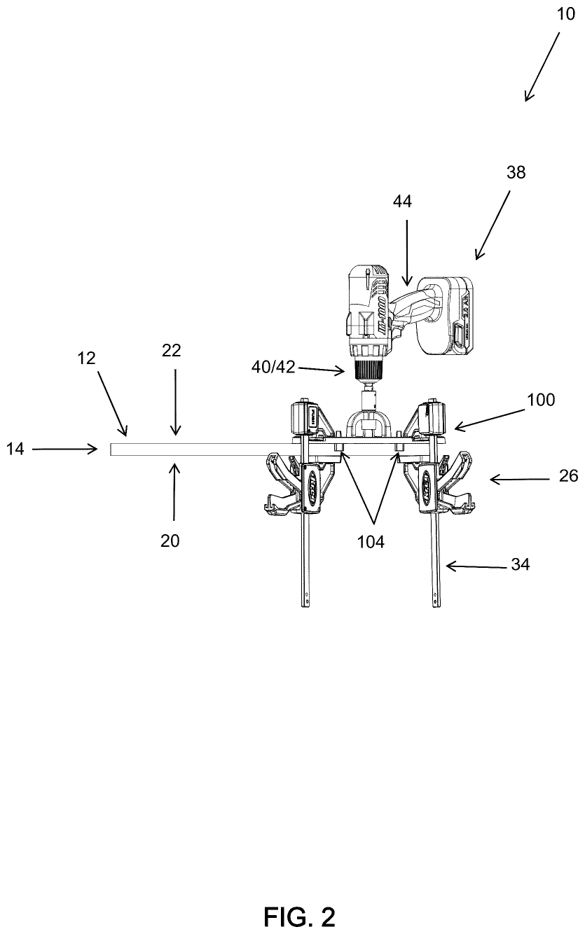

FIG. 3 shows a front view of a system for drilling concealed hinge pocket holes, in accordance with one or more arrangements; the view showing the system clamped to a workpiece for drilling a concealed hinge pocket hole therein.

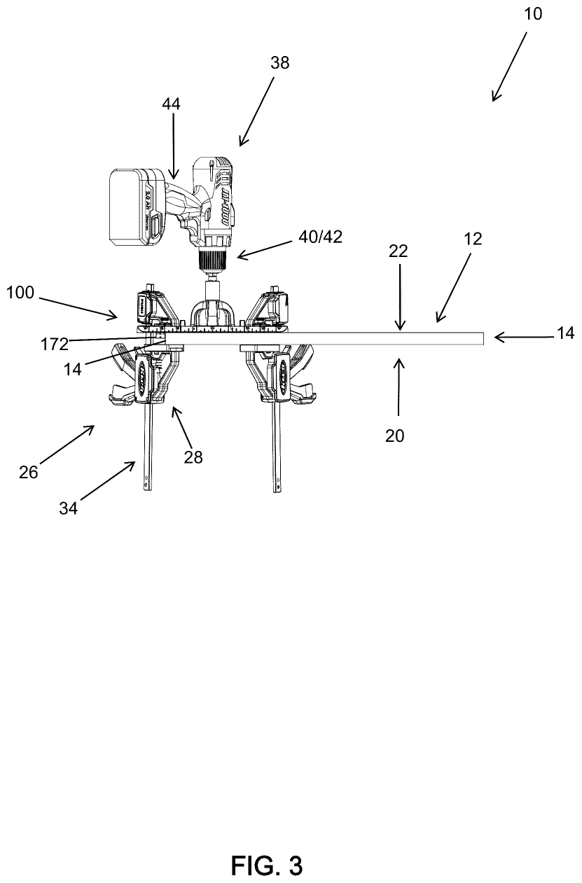

FIG. 4 shows an upper front right view of a system for drilling concealed hinge pocket holes, in accordance with one or more arrangements; the view showing the system positioned on a workpiece and a clamp positioned for clamping the system and workpiece together.

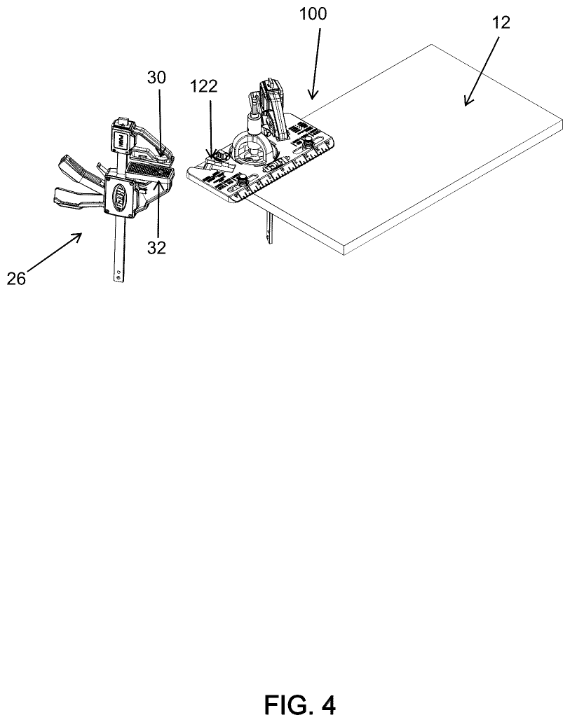

FIG. 5 shows a top view of a system for drilling concealed hinge pocket holes, in accordance with one or more arrangements; the view showing the system clamped to a workpiece for drilling a concealed hinge pocket hole therein.

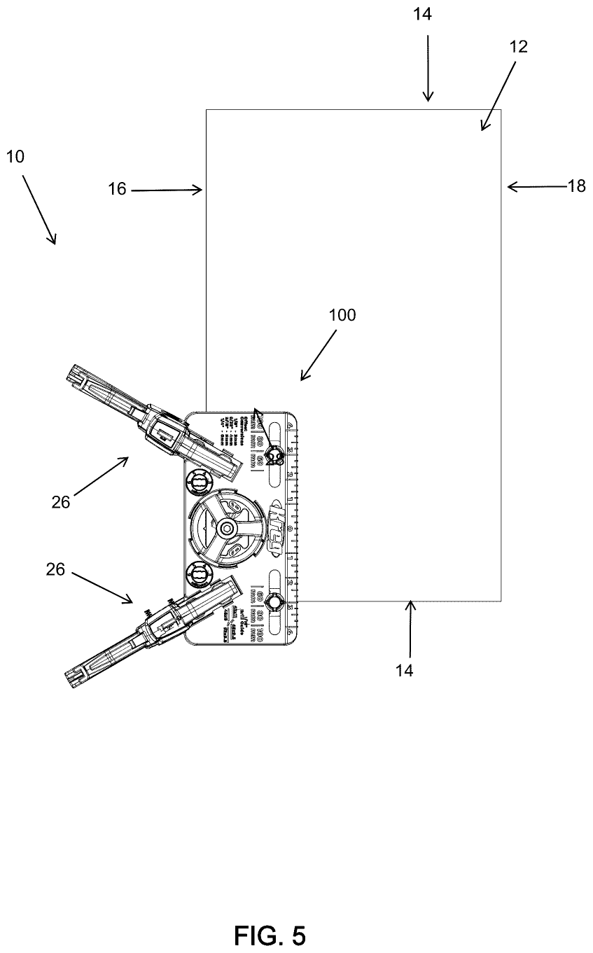

FIG. 6 shows an upper front left perspective view of a jig assembly of a system for drilling concealed hinge pocket holes, in accordance with one or more arrangements.

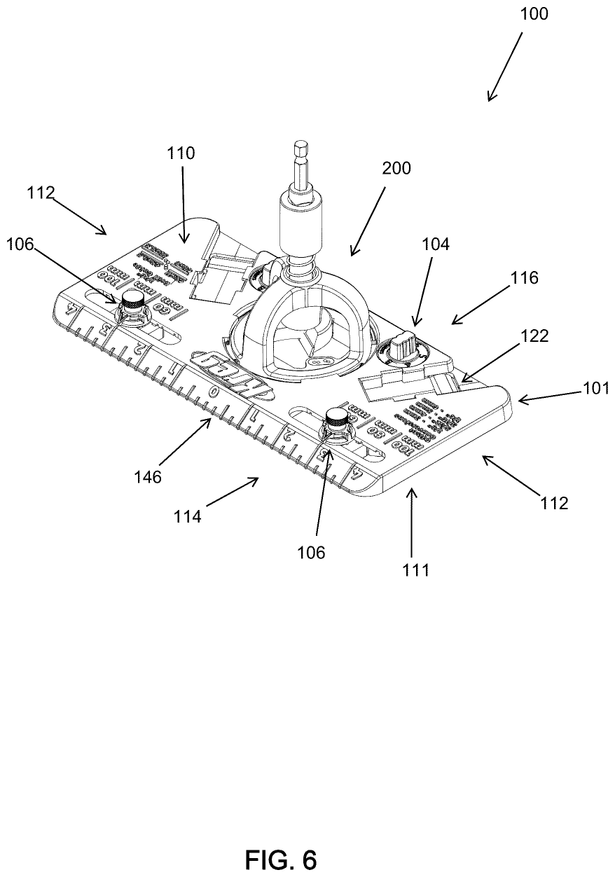

FIG. 7 shows an upper rear right perspective view of a jig assembly of a system for drilling concealed hinge pocket holes, in accordance with one or more arrangements.

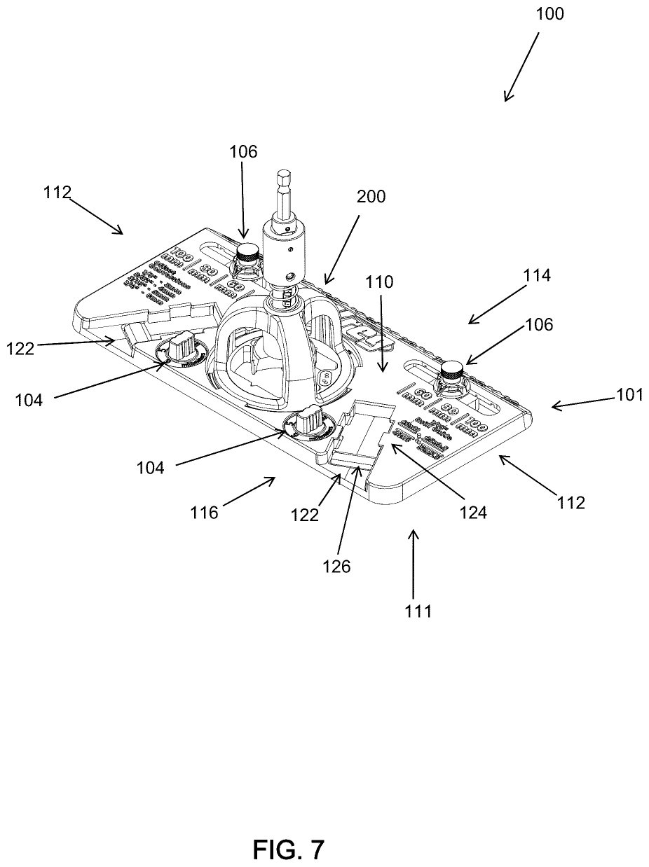

FIG. 8 shows a rear view of a jig assembly of a system for drilling concealed hinge pocket holes, in accordance with one or more arrangements.

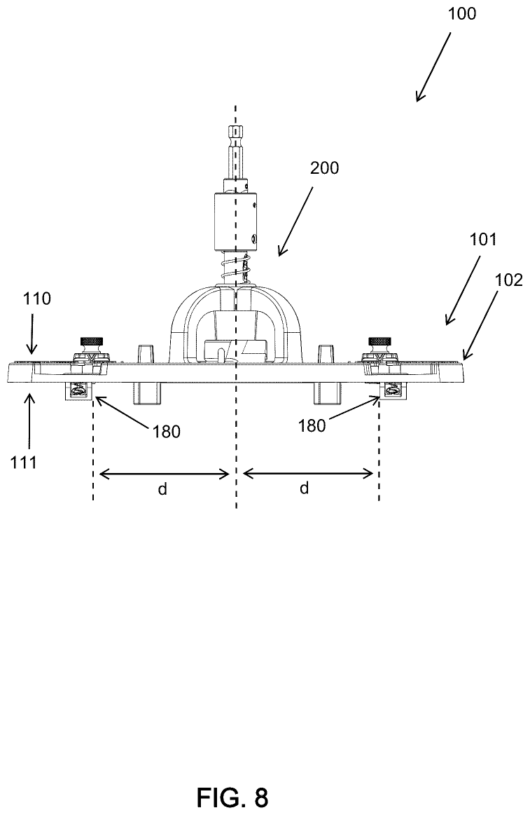

FIG. 9 shows a front view of a jig assembly of a system for drilling concealed hinge pocket holes, in accordance with one or more arrangements.

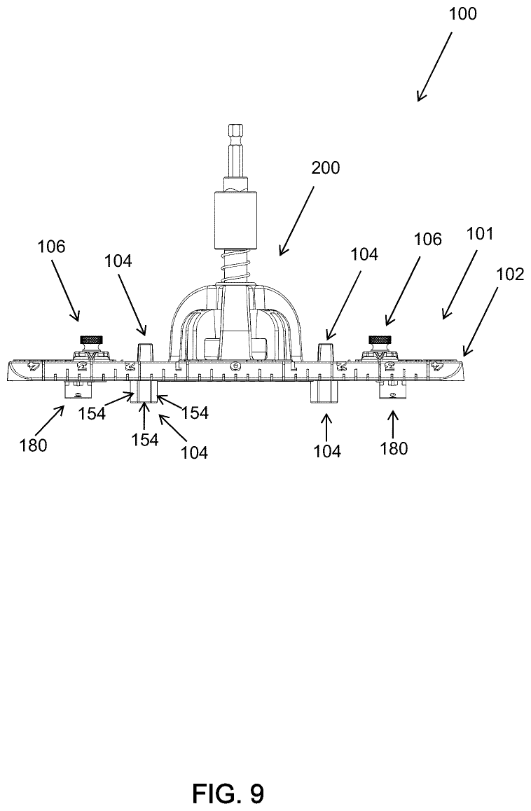

FIG. 10 shows a left side view of a jig assembly of a system for drilling concealed hinge pocket holes, in accordance with one or more arrangements.

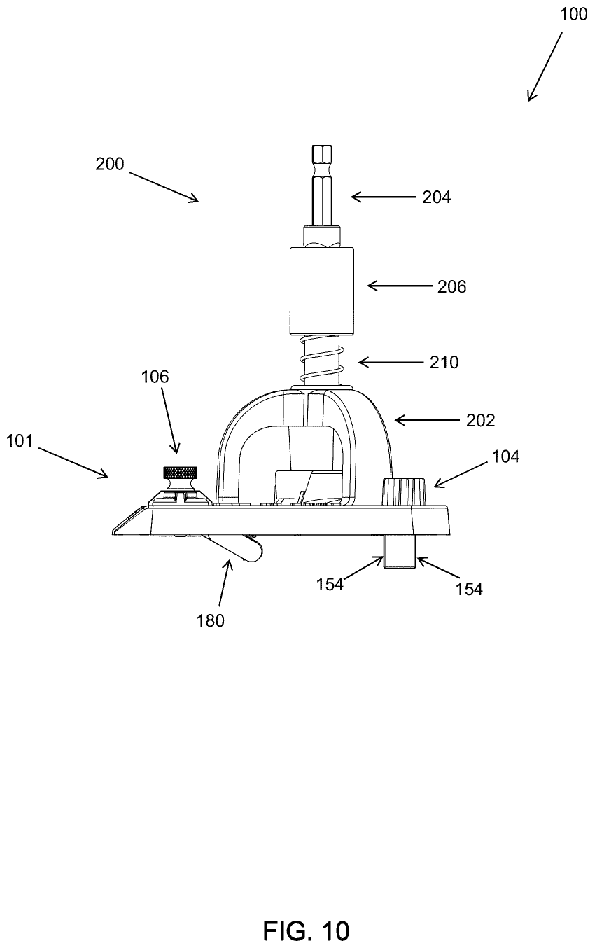

FIG. 11 shows a top view of a jig assembly of a system for drilling concealed hinge pocket holes, in accordance with one or more arrangements.

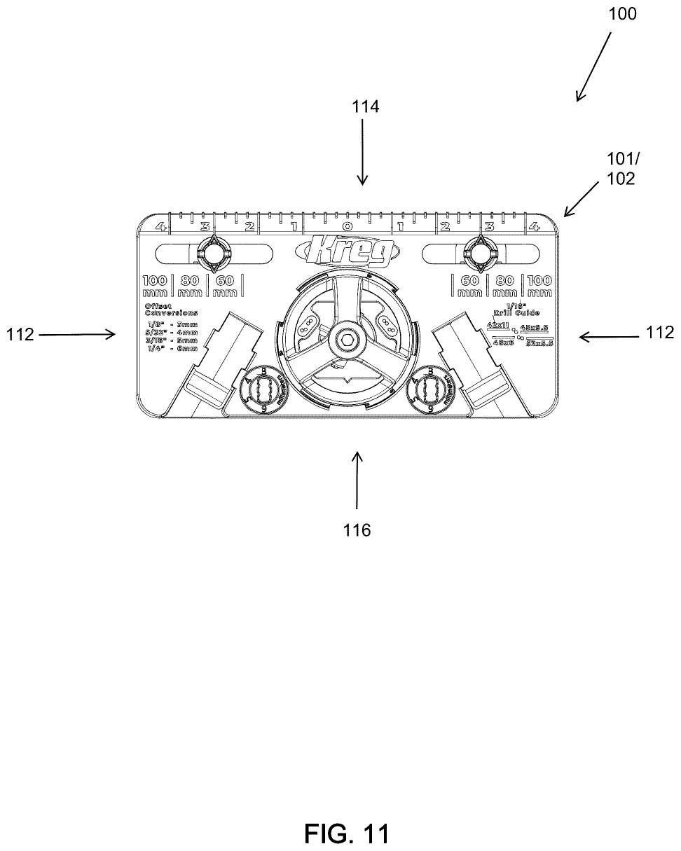

FIG. 12 shows a bottom view of a jig assembly of a system for drilling concealed hinge pocket holes, in accordance with one or more arrangements.

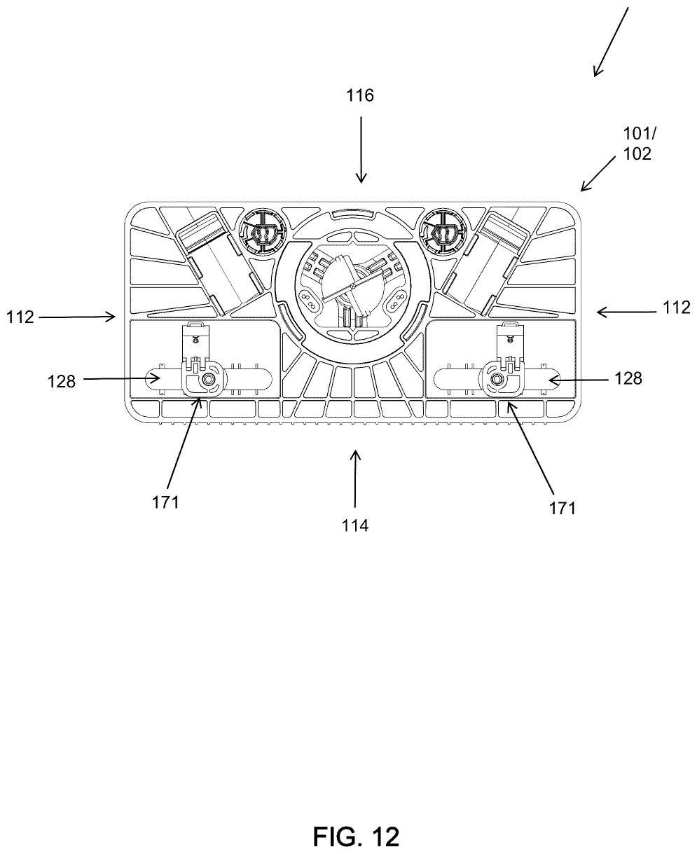

FIG. 13 shows a lower rear left perspective view of a jig assembly of a system for drilling concealed hinge pocket holes, in accordance with one or more arrangements.

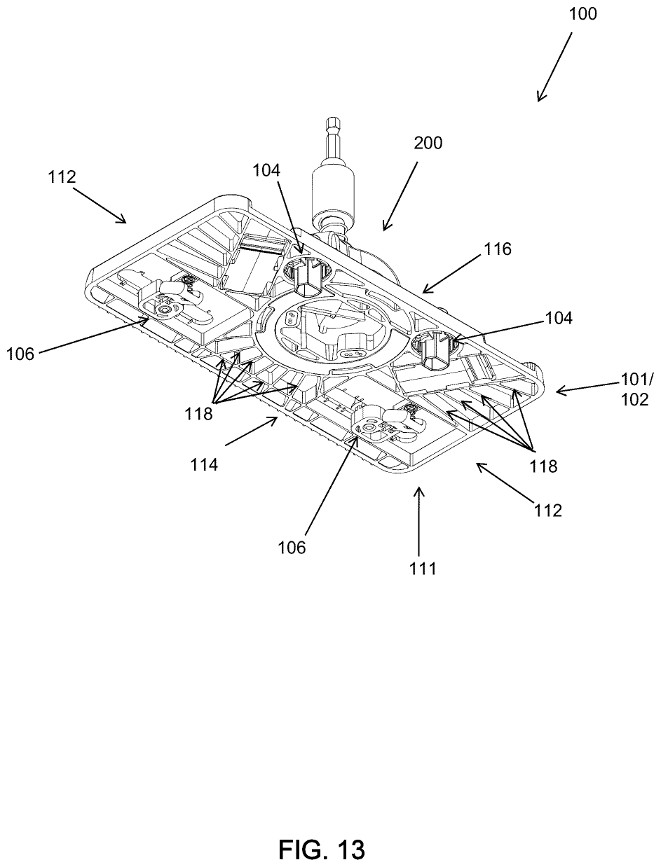

FIG. 14 shows a lower front right perspective view of a jig assembly of a system for drilling concealed hinge pocket holes, in accordance with one or more arrangements.

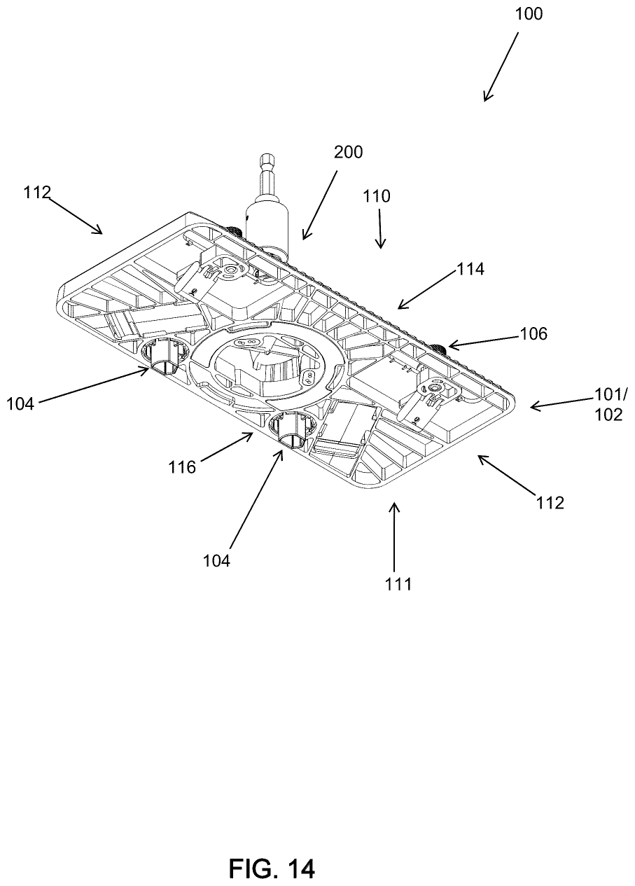

FIG. 15 shows an exploded upper rear right perspective view of a jig assembly of a system for drilling concealed hinge pocket holes, in accordance with one or more arrangements.

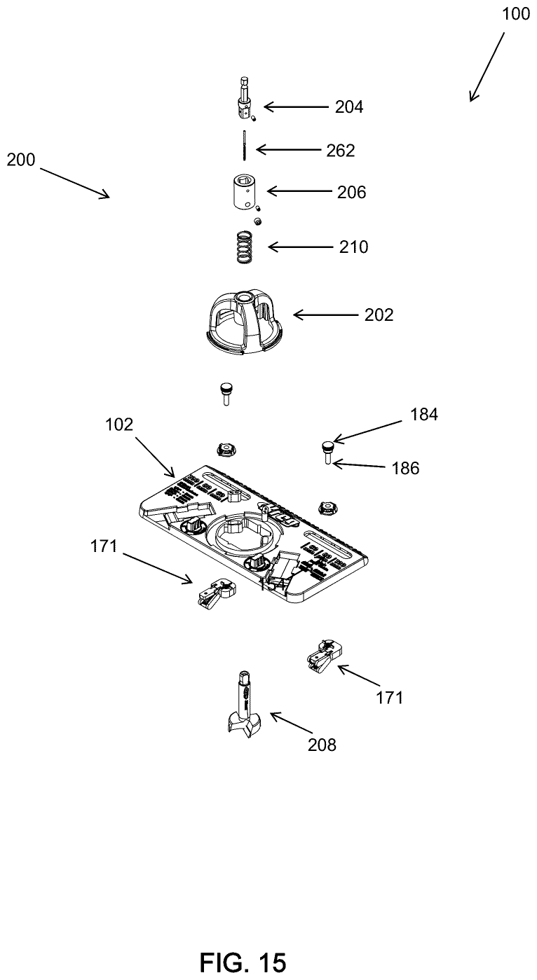

FIG. 16 shows an upper rear right perspective view of a base of a jig assembly of a system for drilling concealed hinge pocket holes, in accordance with one or more arrangements.

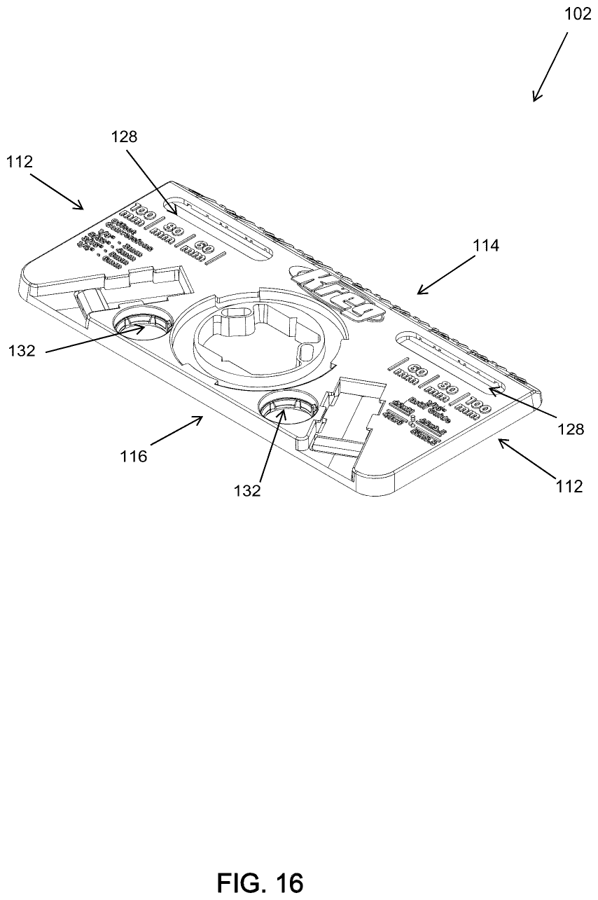

FIG. 17 shows an upper front left perspective view of a base of a jig assembly of a system for drilling concealed hinge pocket holes, in accordance with one or more arrangements.

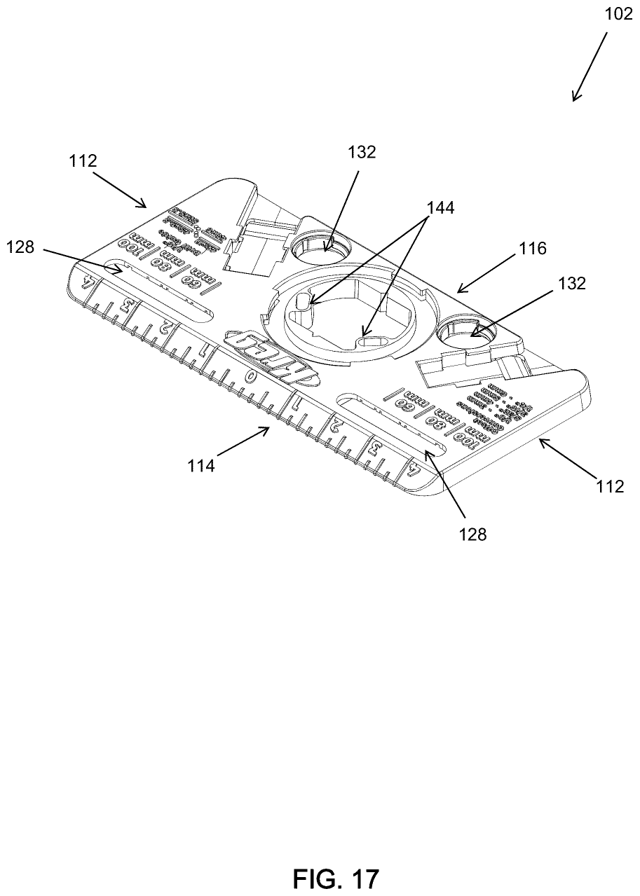

FIG. 18 shows a lower rear left perspective view of a base of a jig assembly of a system for drilling concealed hinge pocket holes, in accordance with one or more arrangements.

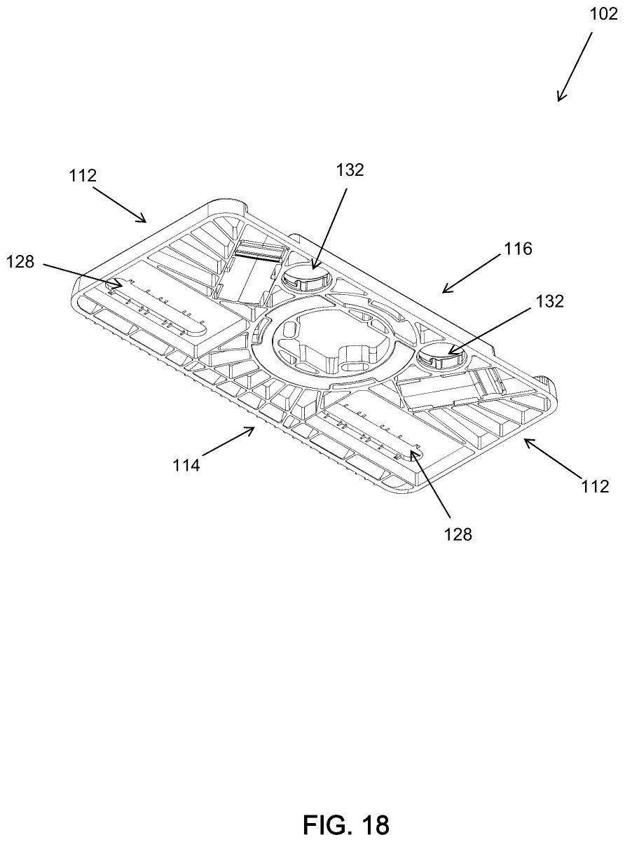

FIG. 19 shows a lower front right perspective view of a base of a jig assembly of a system for drilling concealed hinge pocket holes, in accordance with one or more arrangements.

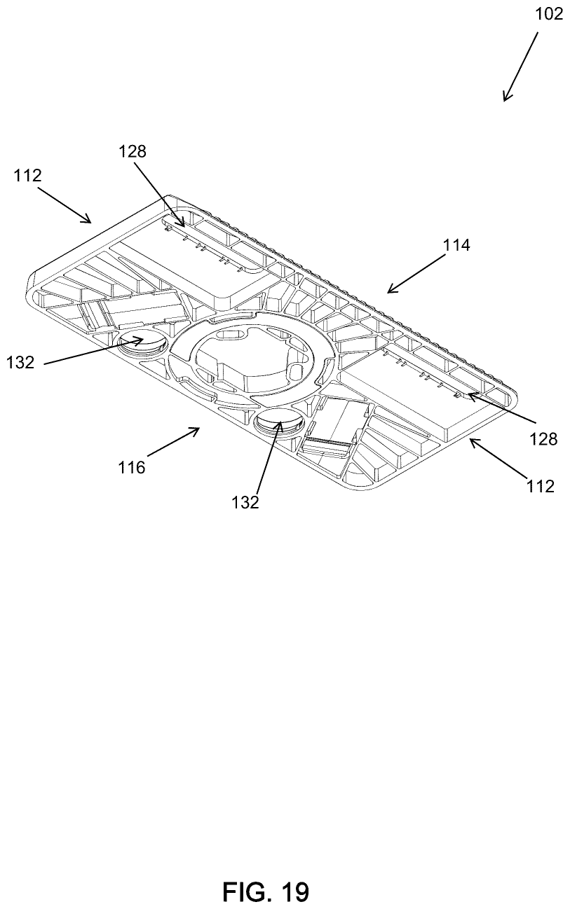

FIG. 20 shows a top view of a base of a jig assembly of a system for drilling concealed hinge pocket holes, in accordance with one or more arrangements.

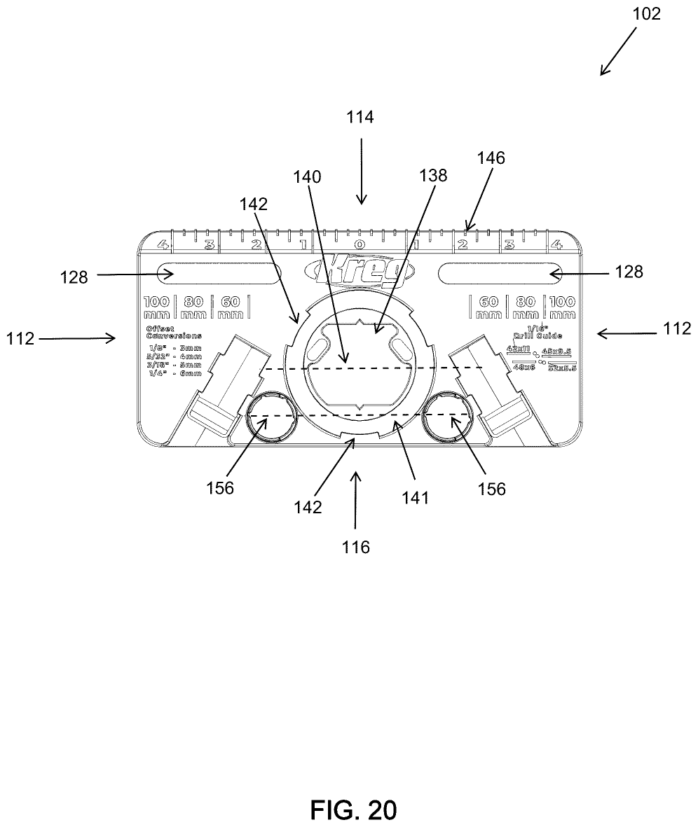

FIG. 21 shows a bottom view of a base of a jig assembly of a system for drilling concealed hinge pocket holes, in accordance with one or more arrangements.

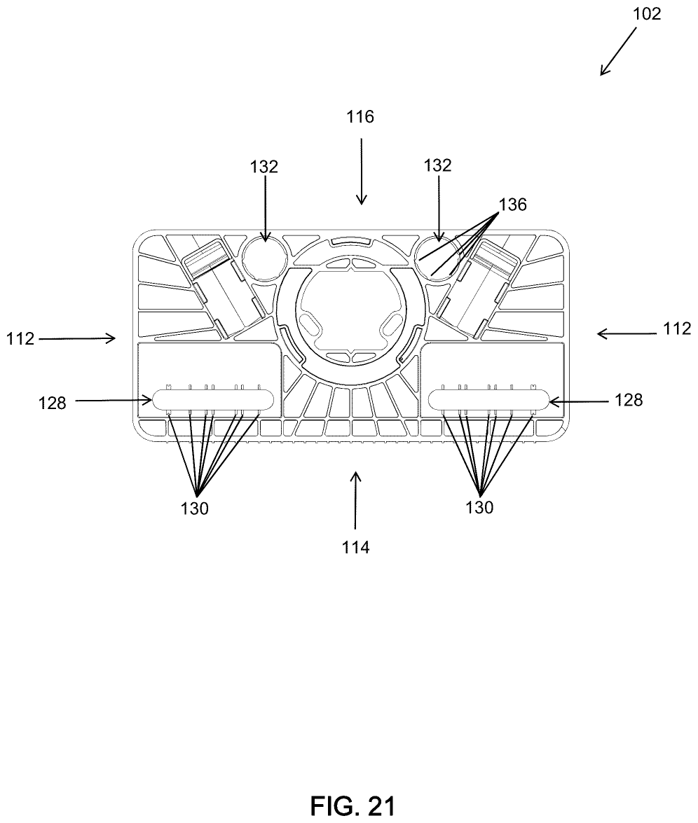

FIG. 22 shows a front view of a base of a jig assembly of a system for drilling concealed hinge pocket holes, in accordance with one or more arrangements.

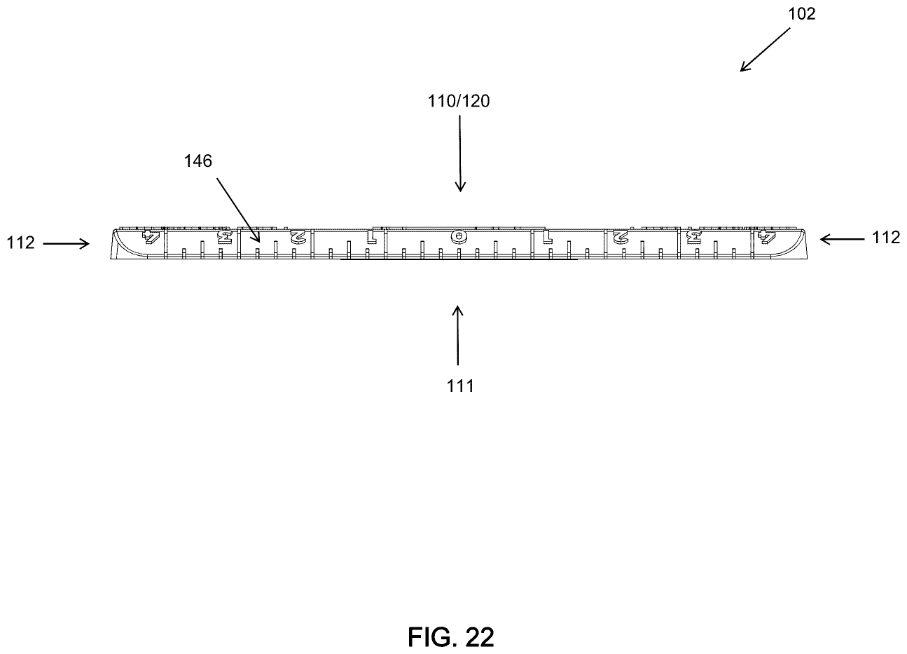

FIG. 23 shows a rear view of a base of a jig assembly of a system for drilling concealed hinge pocket holes, in accordance with one or more arrangements.

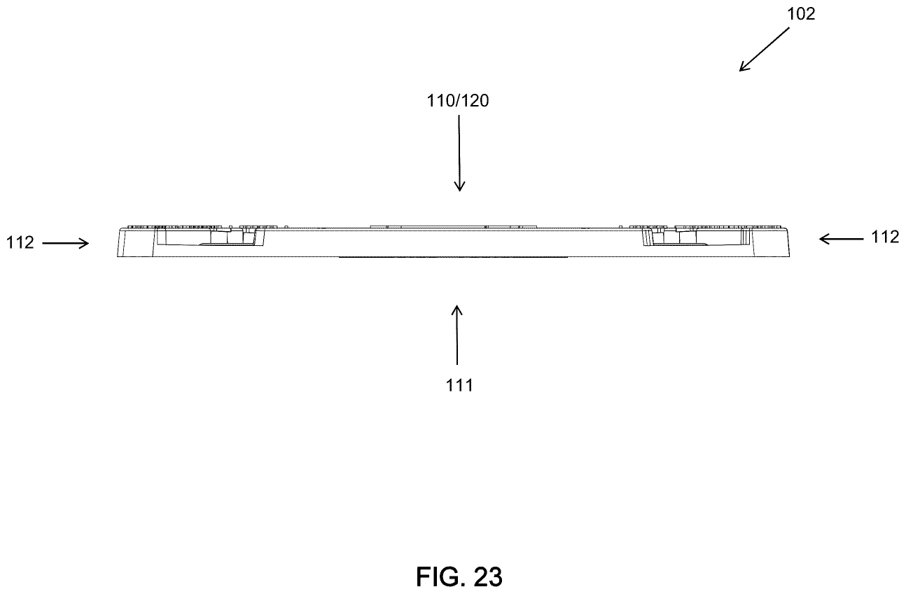

FIG. 24 shows a left side view of a base of a jig assembly of a system for drilling concealed hinge pocket holes, in accordance with one or more arrangements.

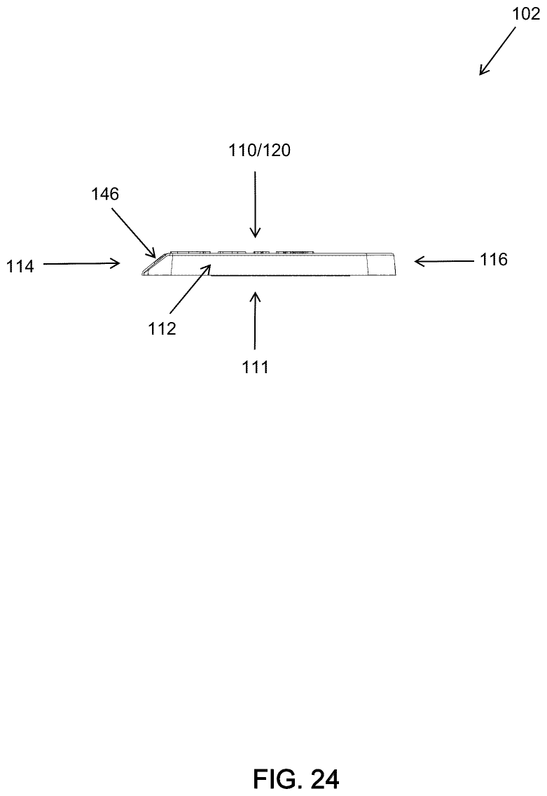

FIG. 25 shows a right side view of a base of a jig assembly of a system for drilling concealed hinge pocket holes, in accordance with one or more arrangements.

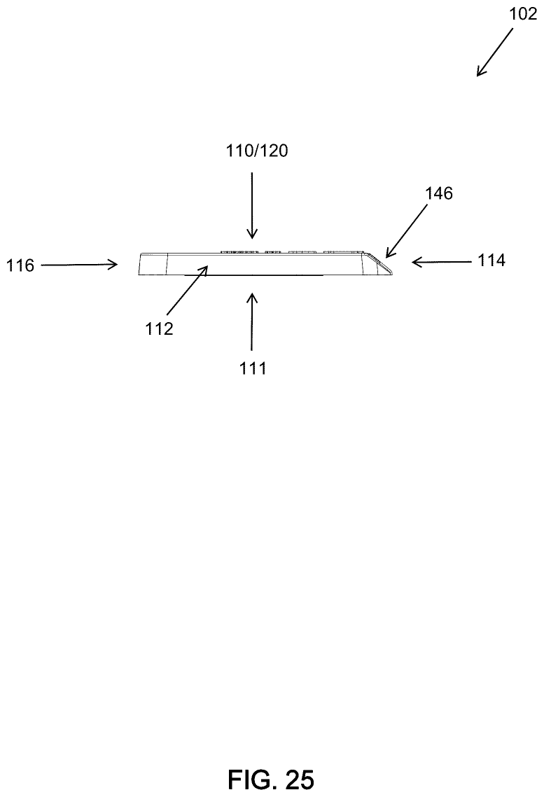

FIG. 26 shows an upper perspective view of a bit guide assembly of a jig assembly of a system for drilling concealed hinge pocket holes, in accordance with one or more arrangements.

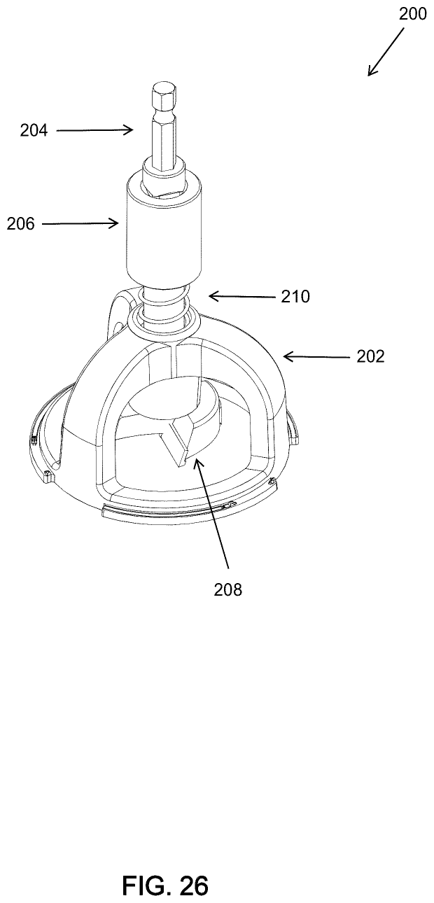

FIG. 27 shows a lower perspective view of a bit guide assembly of a jig assembly of a system for drilling concealed hinge pocket holes, in accordance with one or more arrangements.

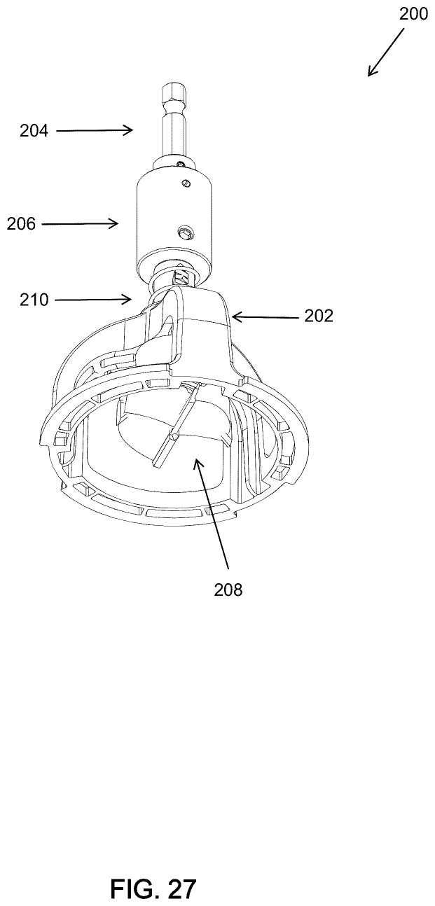

FIG. 28 shows an upper perspective view of a bit guide of a bit guide assembly of a jig assembly of a system for drilling concealed hinge pocket holes, in accordance with one or more arrangements.

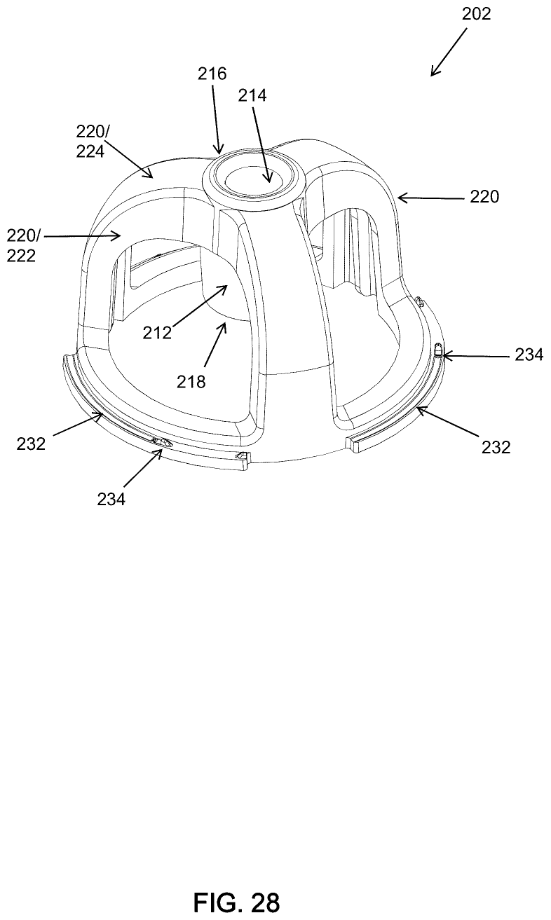

FIG. 29 shows a lower perspective view of a bit guide of a bit guide assembly of a jig assembly of a system for drilling concealed hinge pocket holes, in accordance with one or more arrangements.

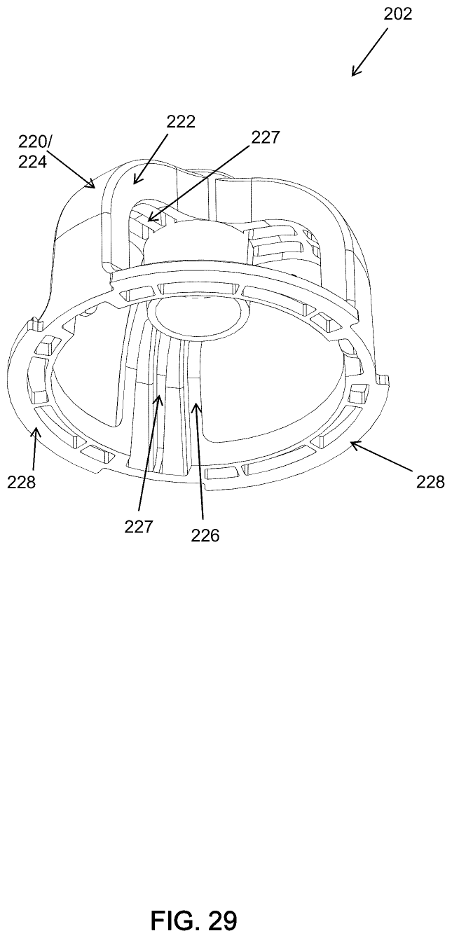

FIG. 30 shows a front view of a bit guide of a bit guide assembly of a jig assembly of a system for drilling concealed hinge pocket holes, in accordance with one or more arrangements.

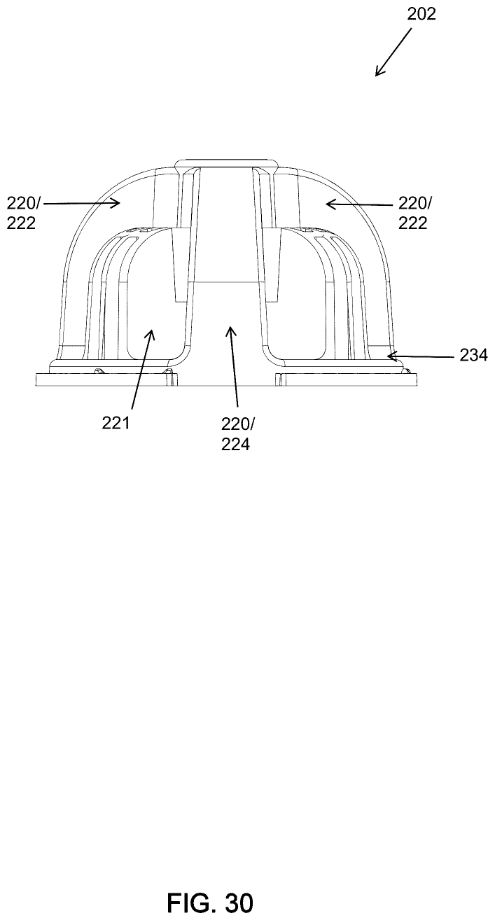

FIG. 31 shows a rear view of a bit guide of a bit guide assembly of a jig assembly of a system for drilling concealed hinge pocket holes, in accordance with one or more arrangements.

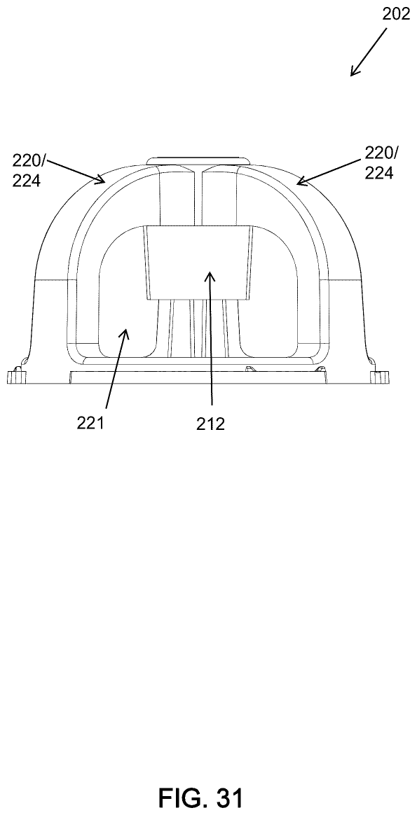

FIG. 32 shows a bottom view of a bit guide of a bit guide assembly of a jig assembly of a system for drilling concealed hinge pocket holes, in accordance with one or more arrangements.

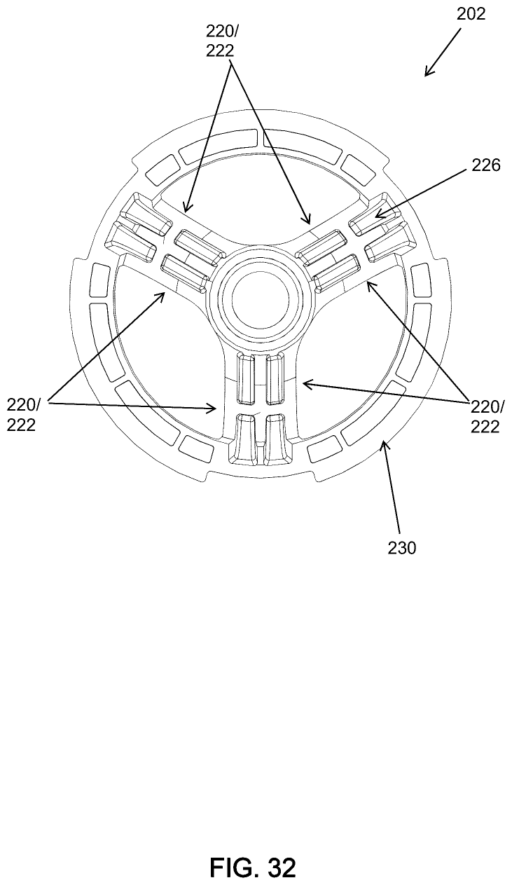

FIG. 33 shows a top view of a bit guide of a bit guide assembly of a jig assembly of a system for drilling concealed hinge pocket holes, in accordance with one or more arrangements.

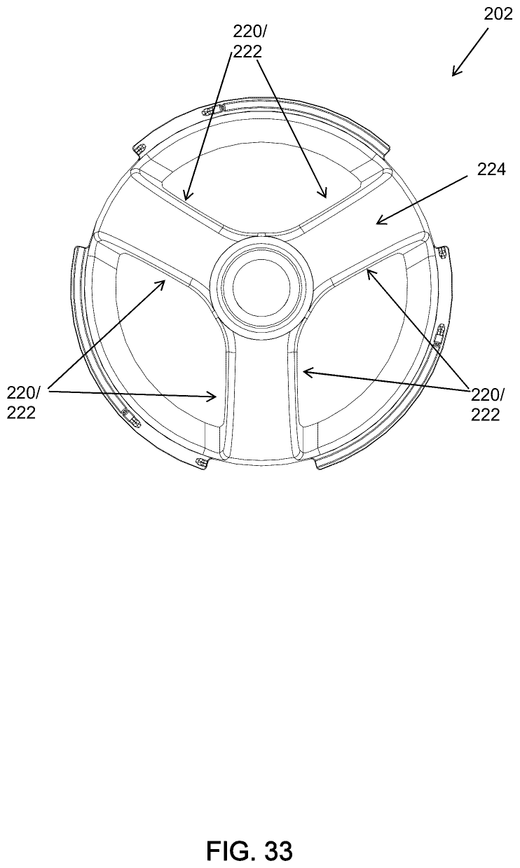

FIG. 34 shows an exploded elevated perspective view of a square fitting assembly, stop collar, and boring bit for use in a system for drilling concealed hinge pocket holes, in accordance with one or more arrangements.

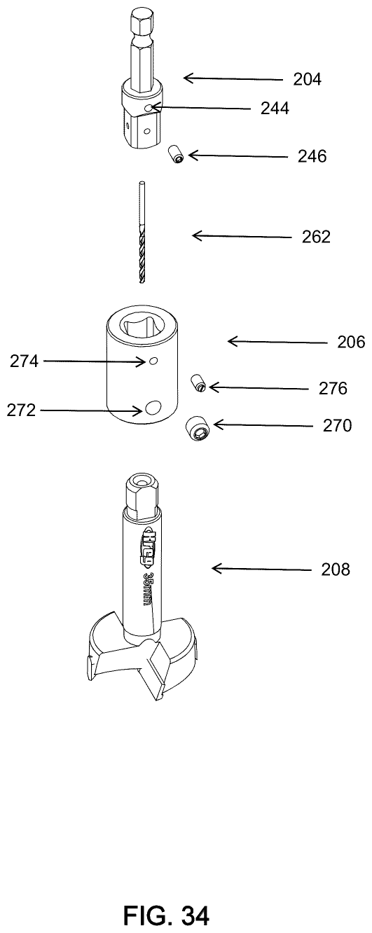

FIG. 35 shows a side assembled view of a square fitting assembly, stop collar, and boring bit for use in a system for drilling concealed hinge pocket holes, in accordance with one or more arrangements.

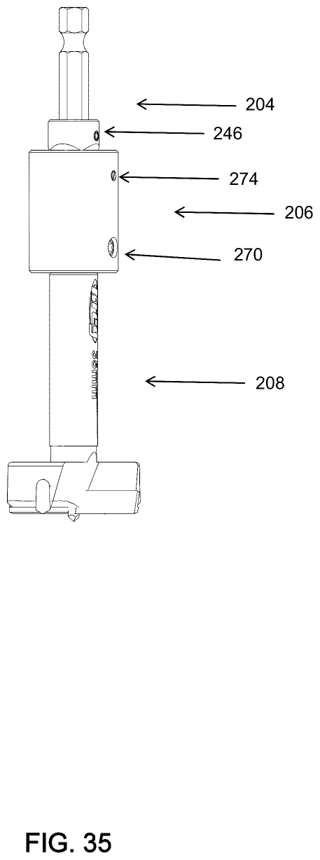

FIG. 36 shows an assembled upper perspective view of a square fitting assembly, stop collar, and a boring bit for use in a system for drilling concealed hinge pocket holes, in accordance with one or more arrangements.

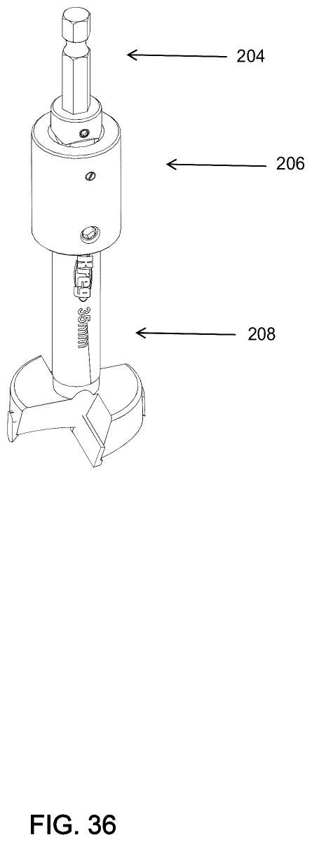

FIG. 37 shows an assembled lower perspective view of a square fitting assembly, stop collar, and a boring bit for use in a bit guide assembly of a system for drilling concealed hinge pocket holes, in accordance with one or more arrangements.

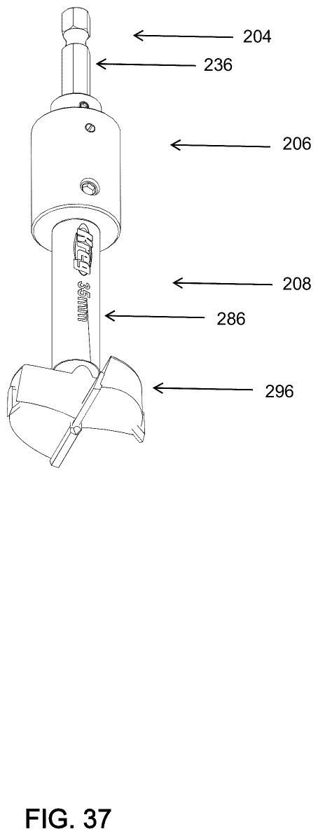

FIG. 38 shows a lower perspective view of a boring bit for use in a bit guide assembly of a system for drilling concealed hinge pocket holes, in accordance with one or more arrangements.

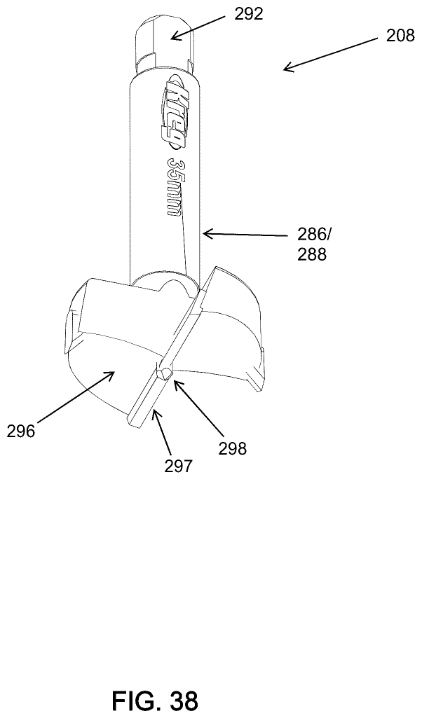

FIG. 39 shows an upper perspective view of a boring bit for use in a bit guide assembly of a system for drilling concealed hinge pocket holes, in accordance with one or more arrangements.

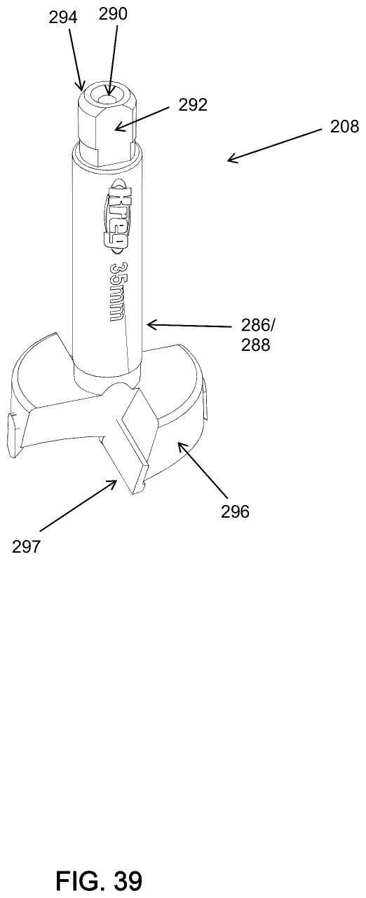

FIG. 40 shows an upper perspective view of a stop collar for use in a bit guide assembly of a system for drilling concealed hinge pocket holes, in accordance with one or more arrangements.

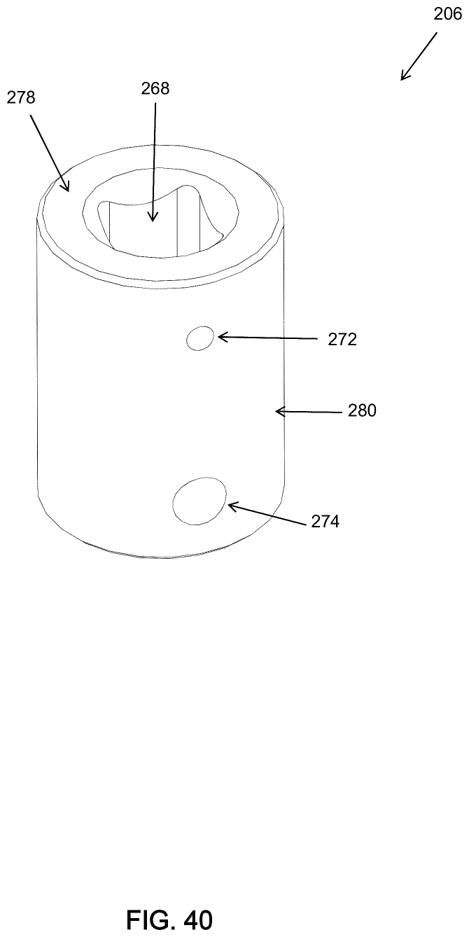

FIG. 41 shows a lower perspective view of a stop collar for use in a bit guide assembly of a system for drilling concealed hinge pocket holes, in accordance with one or more arrangements.

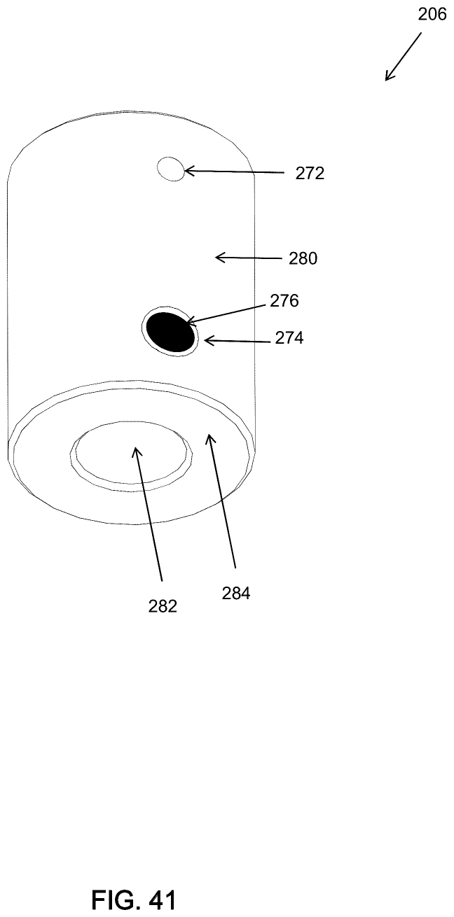

FIG. 42 shows a side view of a square fitting assembly for use in a bit guide assembly of a system for drilling concealed hinge pocket holes, in accordance with one or more arrangements.

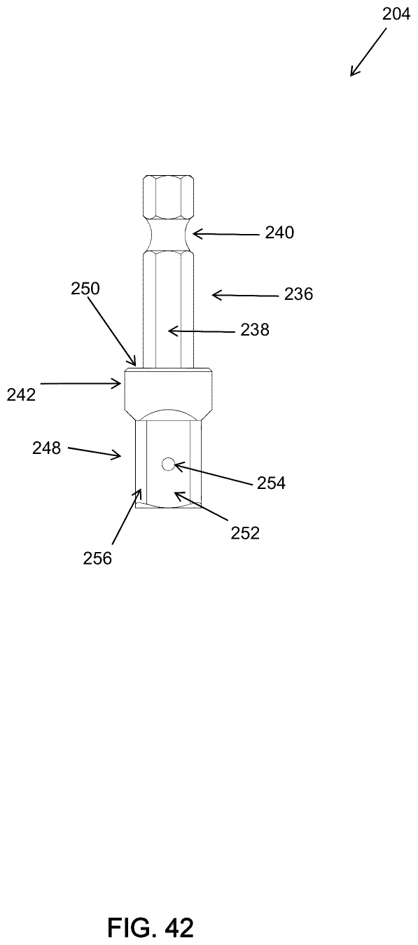

FIG. 43 shows a lower perspective view of a square fitting assembly for use in a bit guide assembly of a system for drilling concealed hinge pocket holes, in accordance with one or more arrangements.

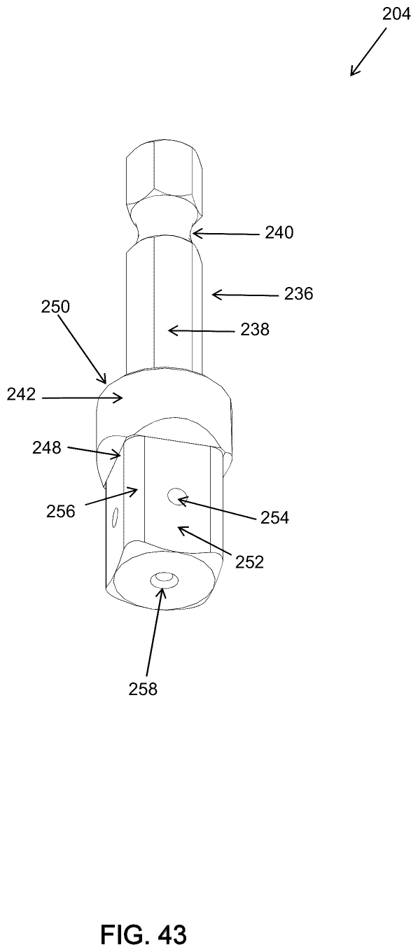

FIG. 44 shows an upper perspective view of a square fitting assembly for use in a bit guide assembly of a system for drilling concealed hinge pocket holes, in accordance with one or more arrangements; the view showing a drill bit held within the square fitting assembly.

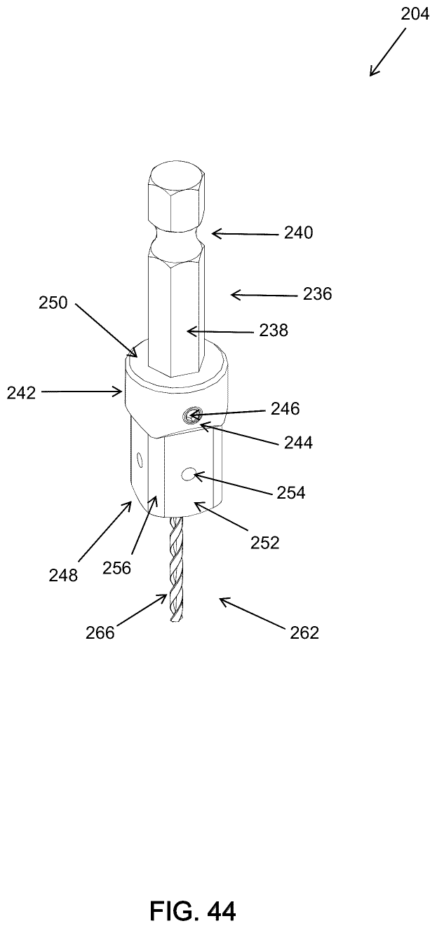

FIG. 45 shows an upper perspective view of a square fitting assembly for use in a bit guide assembly of a system for drilling concealed hinge pocket holes, in accordance with one or more arrangements; the view showing a cross section of the square fitting assembly with a drill bit held therein.

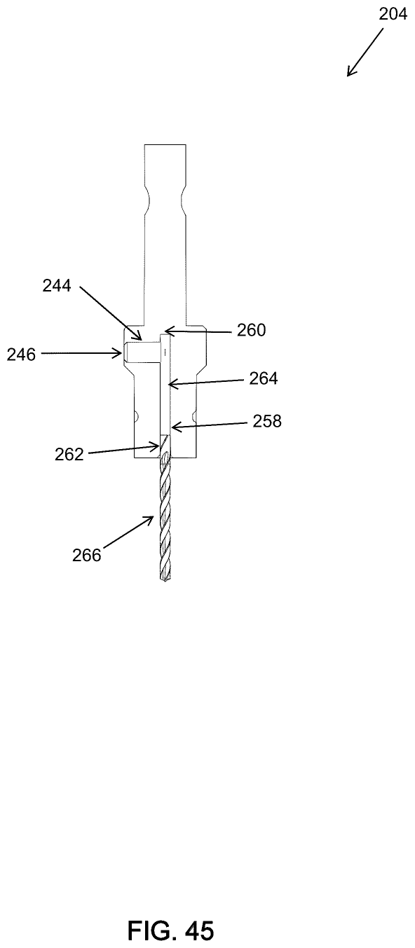

FIG. 46 shows an upper perspective view of an edge knob for use in a base assembly of system for drilling concealed hinge pocket holes, in accordance with one or more arrangements.

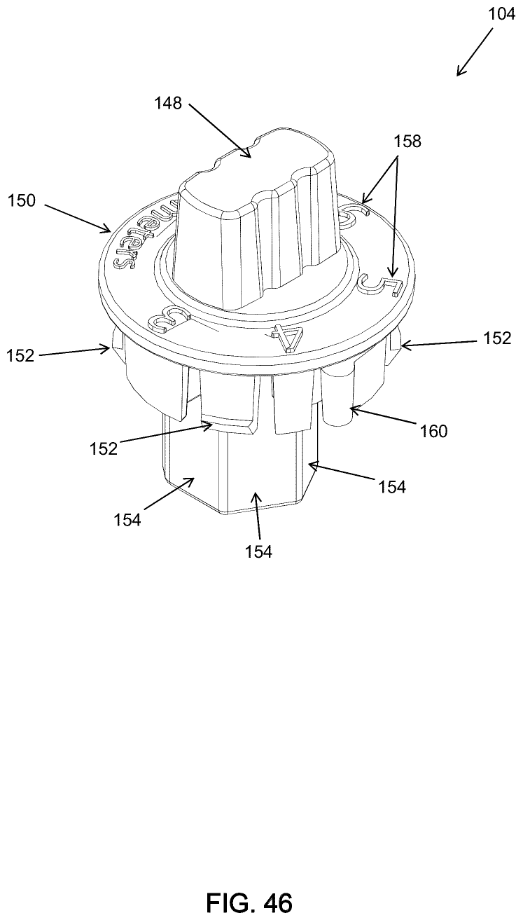

FIG. 47 shows a lower perspective view of an edge knob for use in a base assembly of system for drilling concealed hinge pocket holes, in accordance with one or more arrangements.

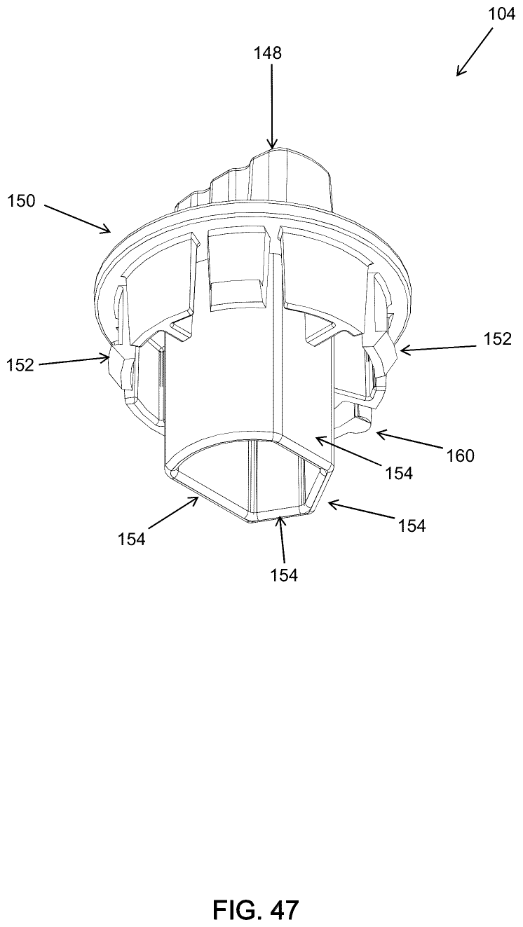

FIG. 48 shows a left side view of an edge knob for use in a base assembly of system for drilling concealed hinge pocket holes, in accordance with one or more arrangements.

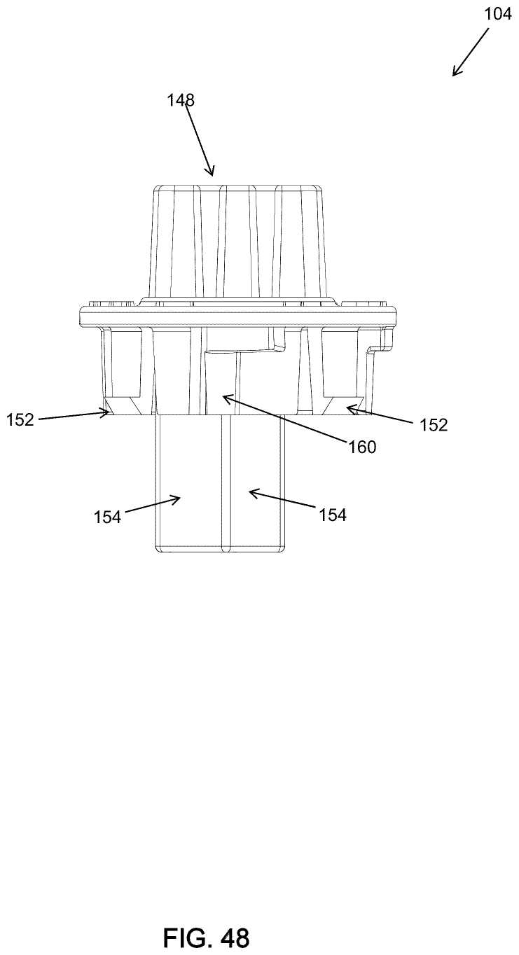

FIG. 49 shows a right side view of an edge knob for use in a base assembly of system for drilling concealed hinge pocket holes, in accordance with one or more arrangements.

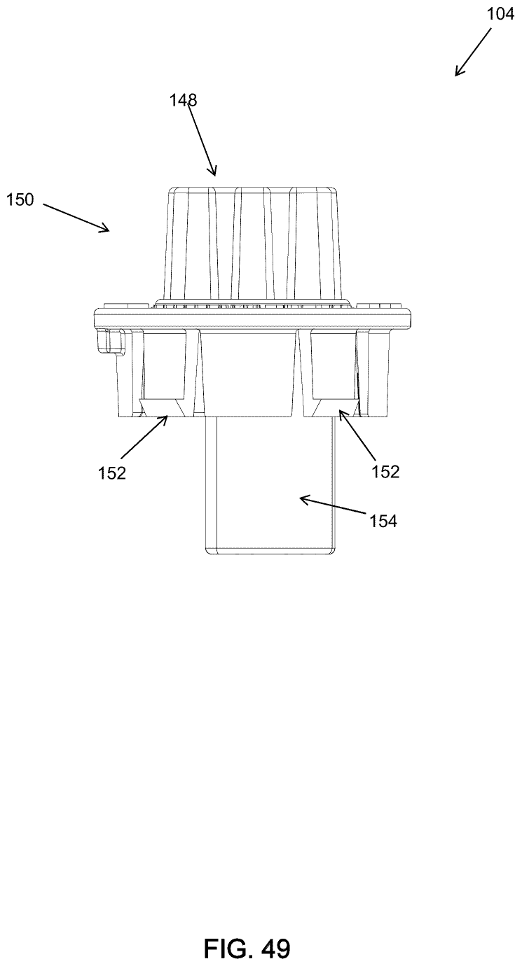

FIG. 50 shows a top view of an edge knob for use in a base assembly of system for drilling concealed hinge pocket holes, in accordance with one or more arrangements.

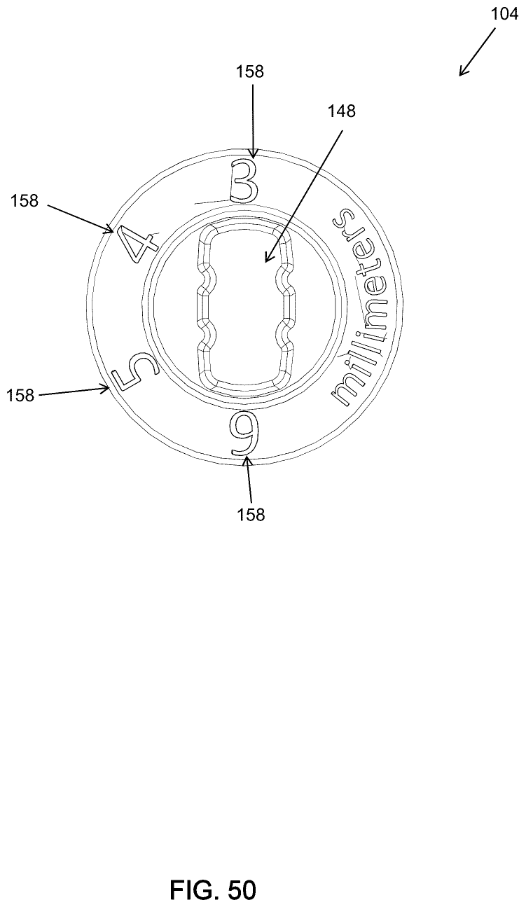

FIG. 51 shows a bottom view of an edge knob for use in a base assembly of system for drilling concealed hinge pocket holes, in accordance with one or more arrangements.

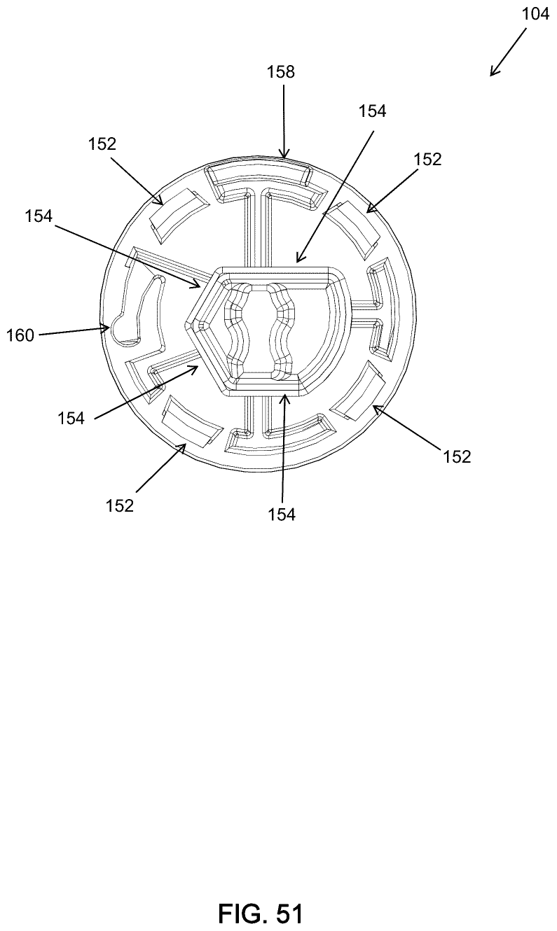

FIG. 52 shows an upper rear left perspective view of a stop block base assembly of a base assembly of system for drilling concealed hinge pocket holes, in accordance with one or more arrangements.

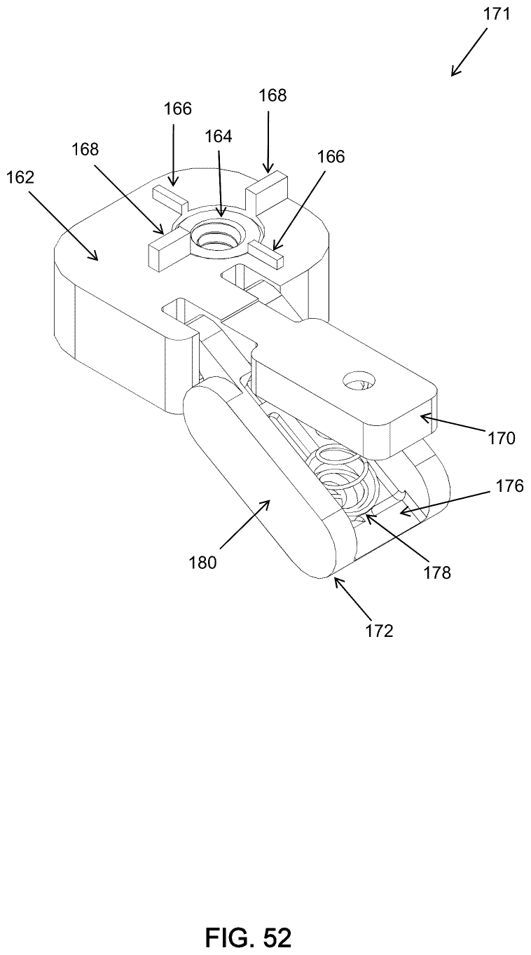

FIG. 53 shows a lower front right perspective view of a stop block base assembly of a base assembly of system for drilling concealed hinge pocket holes, in accordance with one or more arrangements.

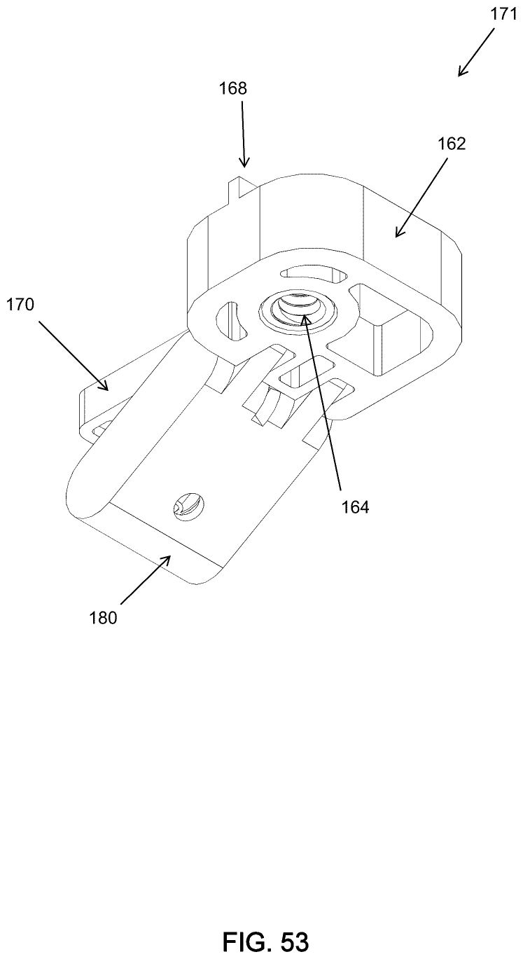

FIG. 54 shows a left side view of a stop block base assembly of a base assembly of system for drilling concealed hinge pocket holes, in accordance with one or more arrangements.

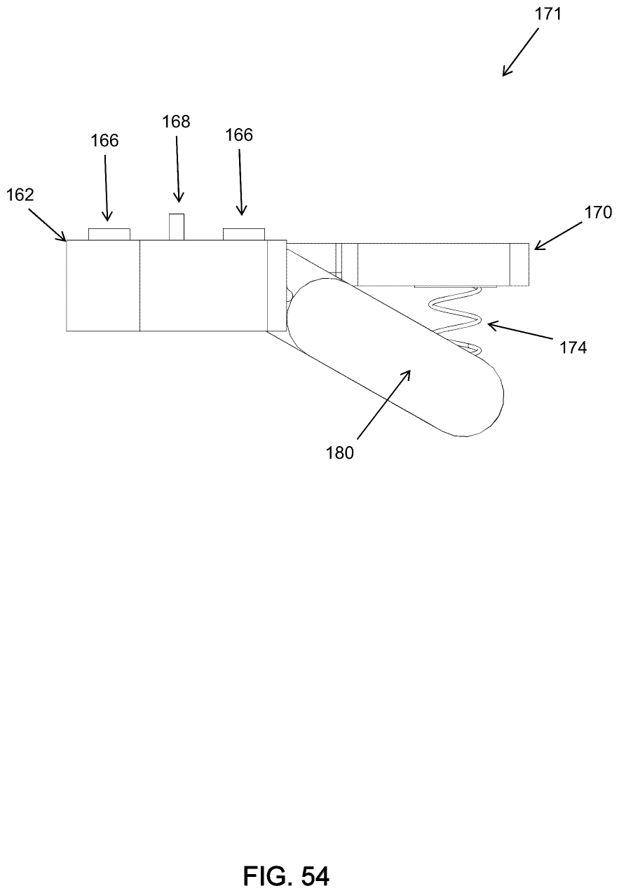

FIG. 55 shows a right side view of a stop block base assembly of a base assembly of system for drilling concealed hinge pocket holes, in accordance with one or more arrangements.

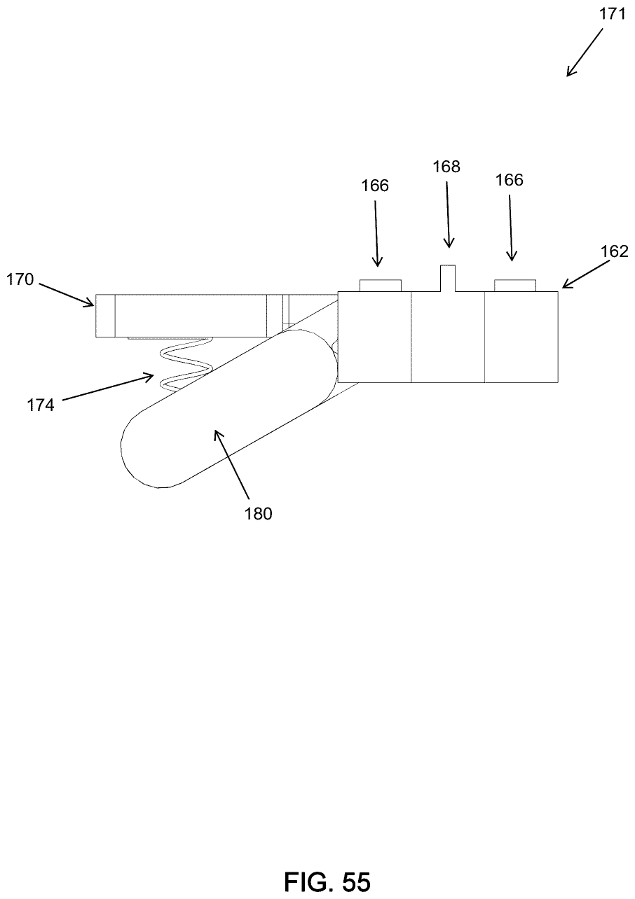

FIG. 56 shows a bottom view of a stop block base assembly of a base assembly of system for drilling concealed hinge pocket holes, in accordance with one or more arrangements.

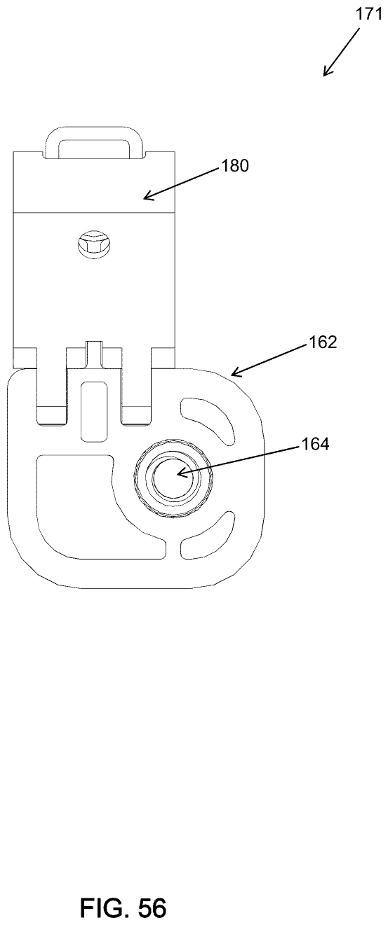

FIG. 57 shows a top view of a stop block base assembly of a base assembly of system for drilling concealed hinge pocket holes, in accordance with one or more arrangements.

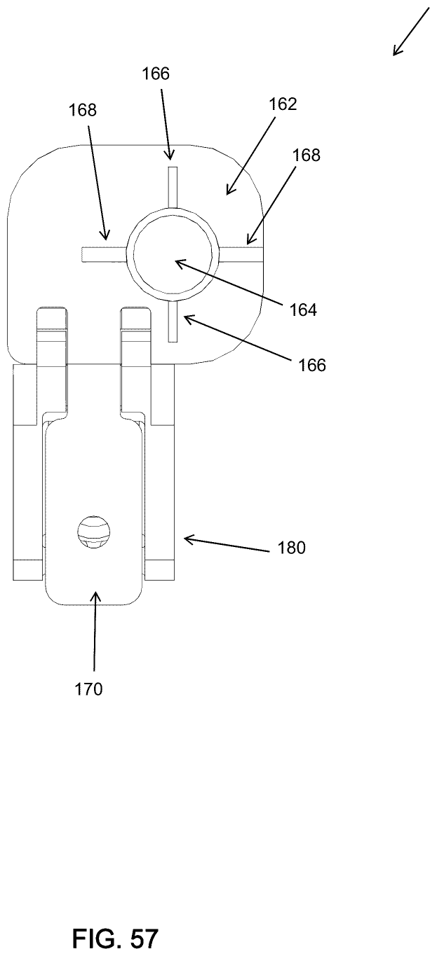

FIG. 58 shows a front view of a stop block base assembly of a base assembly of system for drilling concealed hinge pocket holes, in accordance with one or more arrangements.

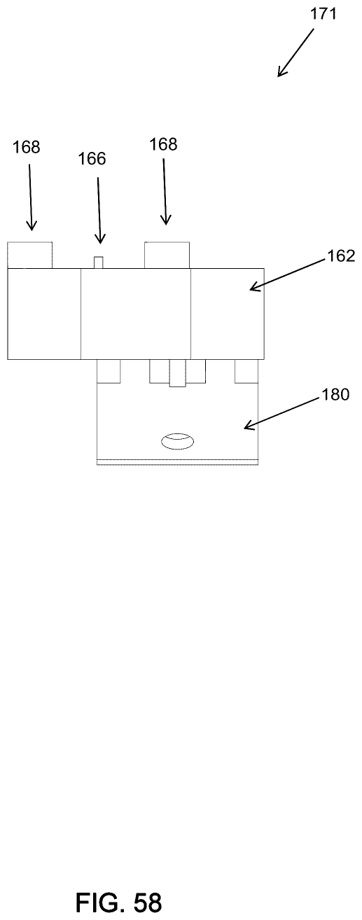

FIG. 59 shows a rear view of a stop block base assembly of a base assembly of system for drilling concealed hinge pocket holes, in accordance with one or more arrangements.

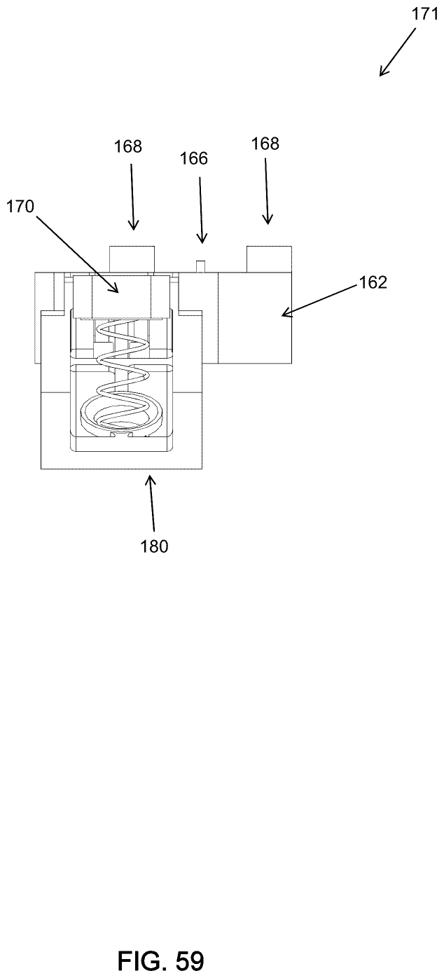

FIG. 60 shows an elevated perspective view of a pilot hole bushing for a system for drilling concealed hinge pocket holes, in accordance with one or more arrangements.

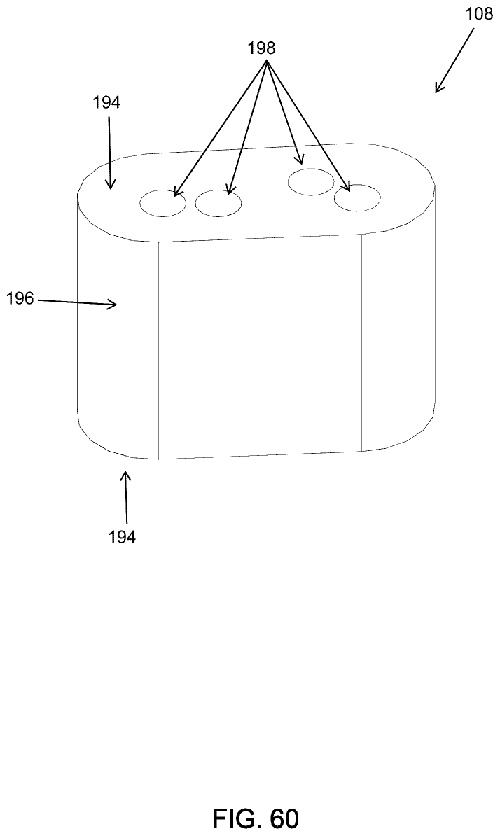

FIG. 61 shows a top view of a pilot hole bushing for a system for drilling concealed hinge pocket holes, in accordance with one or more arrangements.

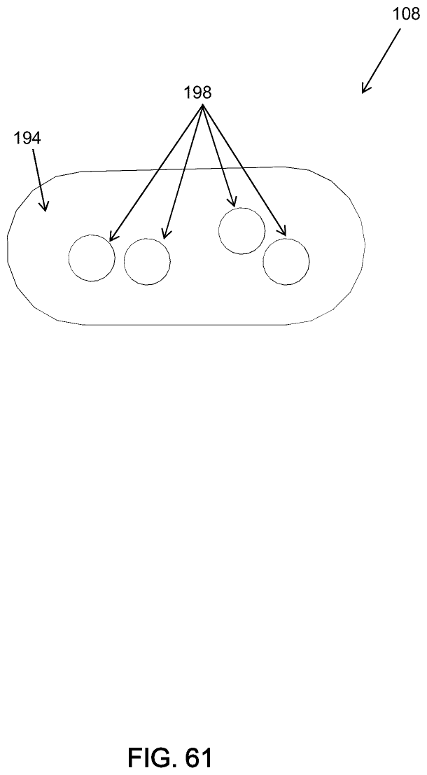

FIG. 62 shows a lower front right perspective view of a set screw assembly of a stop block base assembly of a base assembly of system for drilling concealed hinge pocket holes, in accordance with one or more arrangements.

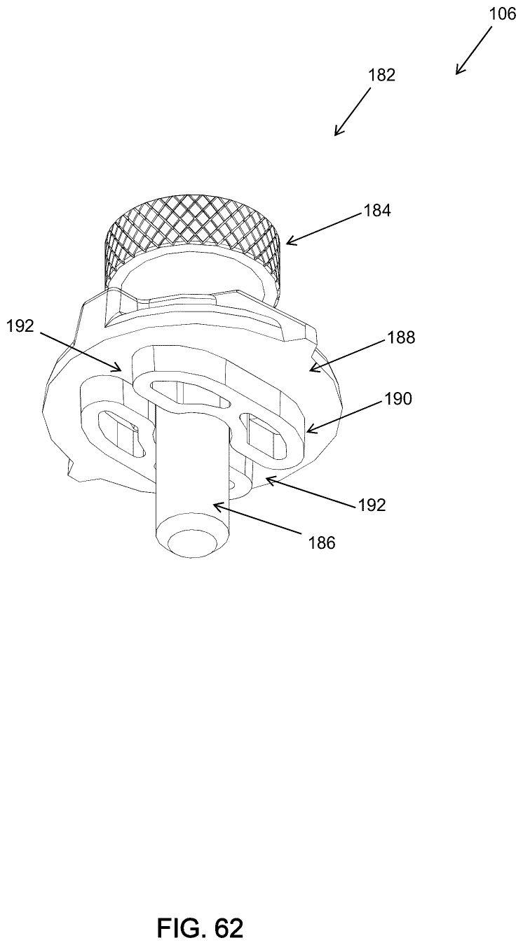

FIG. 63 shows an upper front right perspective view of a set screw assembly of a stop block base assembly of a base assembly of system for drilling concealed hinge pocket holes, in accordance with one or more arrangements.

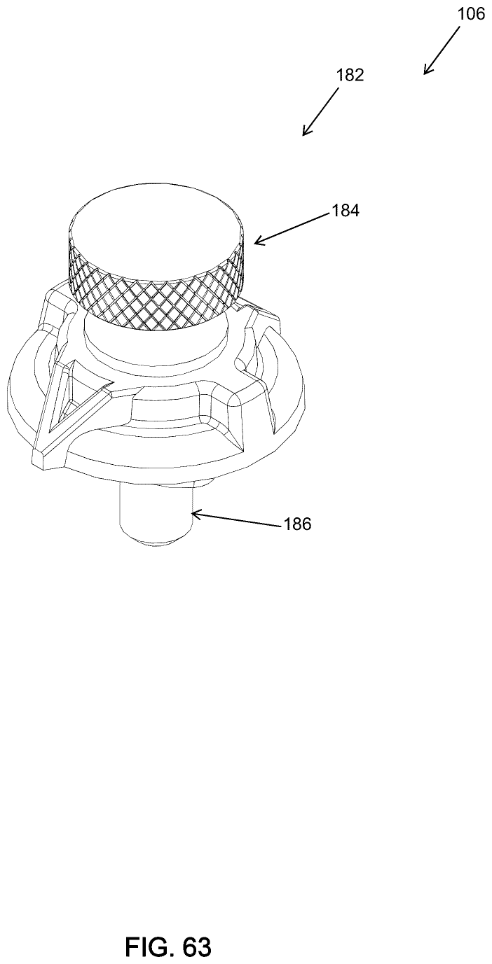

FIG. 64 shows a side view of a set screw assembly of a stop block base assembly of a base assembly of system for drilling concealed hinge pocket holes, in accordance with one or more arrangements.

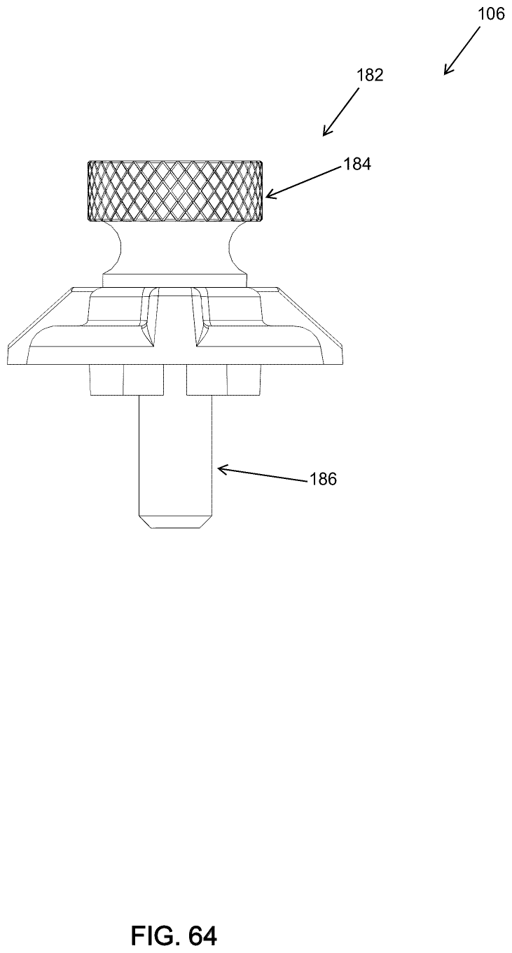

FIG. 65 shows a bottom view of a set screw assembly of a stop block base assembly of a base assembly of system for drilling concealed hinge pocket holes, in accordance with one or more arrangements.

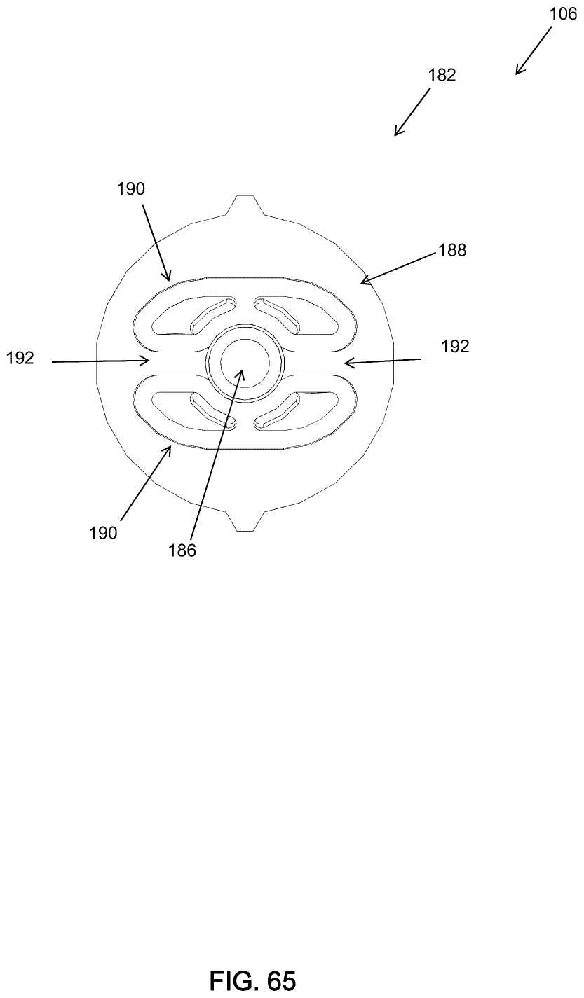

FIG. 66 shows a top view of a set screw assembly of a stop block base assembly of a base assembly of system for drilling concealed hinge pocket holes, in accordance with one or more arrangements.

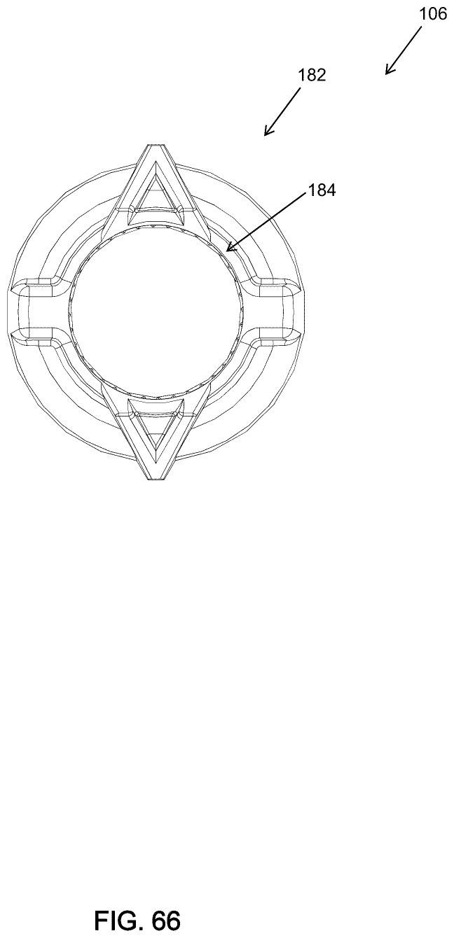

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described as comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of boring jigs. However, the embodiments are not so limited. It is appreciated that the embodiments may be adapted for use in other applications which may be improved by the disclosed structures, arrangements and/or methods. The system is merely shown and described as being used in the context of boring jigs for ease of description and as one of countless examples.

### System

With reference to the figures, a system for aligning and drilling concealed hinge pocket holes 10 (referred to as “system 10” herein) is presented. In the arrangement shown, the system 10 is formed of any suitable size, shape, and design and is configured to accurately, easily, and repeatably drill one or more concealed hinge pocket holes (sometimes referred to as “bores”) in a workpiece such as a cabinet door or the like. In the arrangement shown, as one example, the system 10 includes a concealed hinge boring jig assembly 100 (or simply jig assembly 100) that is held in place on a workpiece 12 using one or more clamps 26 and is configured to attach to a drill 38 as described in detail herein to provide the torque necessary to drill the bore and corresponding pilot holes for attachment of a concealed hinge assembly to the workpiece 12.

### Workpiece

With reference to the figures, a workpiece 12 is presented. Workpiece 12 may be any workpiece, such as, by way of example and not limitation, a cabinet door for kitchen cabinets, bathroom cabinets, garage cabinets, or any other cabinet door. In the arrangement shown, the workpiece 12 is formed of any suitable size, shape, and design and is configured to selectively conceal and/or protect the contents of the interior of a cabinet, while simultaneously proving a pleasing aesthetic to a user. In the arrangement shown, as one example, the workpiece 12 has top and bottom sides 14, a hinge side 16, a handle side 18, front or class-A surface 20, and back surface 22.

In the arrangement shown as one example, workpiece 12 may be formed of a single, unitary member that is formed from a single piece of wood in a manufacturing process such as cutting and machining or the like to form a unitary and monolithic member. Workpiece 12 may also be assembled from a number of pieces of wood and/or non-wood materials, may be completely translucent or include transparent areas or panels, and may be formed of any number of metallic and/or non-metallic materials such as a wooden material, fiberglass, plastic, composite materials, or any other natural or synthetic material that is customary for use on cabinet doors.

In the arrangement shown, when viewed from the front of the workpiece, the geometric shape of the workpiece 12 is a rectangle, longer from top to bottom than from hinge side to handle side, however, workpiece 12 may be formed of any other shape or configuration, including a rectangle that is wider from hinge side to handle side than from top to bottom, an oval, a parallelogram, or any other shape. In the arrangement shown, as one example, when viewed from the top, bottom, or either side the workpiece is in the geometric shape of a thin rectangle, with the thickness of the workpiece 12 visible. The thickness of the workpiece 12 may be thick enough to provide the protection for the contents of the cabinet within, but thin enough to remain east to open and close, typically ½″-¾″ thick.

While workpiece 12 has been described according the arrangement shown, as one example, it will be understood by those skilled in the art that any other configuration of workpiece 12 may be used in order to provide a selectively openable and closable door to a cabinet or any other workpiece that utilizes a concealed hinge.

### Clamps

With reference to the figures, a clamp 26 is presented. Clamp 26 may be any clamp, such, by way of example, a sliding clamp, a fast-action bar clamp, a c-clamp, or any other type of clamp. The clamp 26 is formed of any suitable size, shape, and design and is configured to selectively hold the base assembly 101 of the concealed hinge boring jig assembly 100 in place during the boring and/or drilling process. In the arrangement shown, as one example, a pair of clamps 26 are situated on either side of a handle 44 of a drill 38 to both hold the concealed hinge boring jig assembly 100 in place while keeping the clamp elements out of the way of a user's hand while drilling. In the arrangement shown, as one example, the clamp 26 has a slidable handle 28, a clamping surface 30, a clamping surface flange 32, and a clamping bar 34.

In the arrangement shown, as one example, the clamp 26 may be formed of a number of elements that work together to provide the clamping force necessary to hold the workpiece 12 in place during the drilling and/or boring process. In the arrangement shown, as one example, a pair of clamping surfaces 30 are selectively slidably coupled to a bar 34. One clamping surface 30 is held stationary while the other clamping surface 30 is slid into contact with the jig base 102 or the workpiece 12. In the arrangement shown, as one example, the clamping surface is then tightened applying a force to and holding the base assembly 101 and the workpiece 12 stationary with respect to one another.

In the arrangement shown, as one example, clamping surface 30 is slid into a clamp securing recess 122 of the jig base 102. In the arrangement shown, as one example, the securing recess 122 includes an overhang flange 124. The clamping surface flange 32 corresponds and is coupled to the overhang flange 124 such that the clamping surface 30, and by extension the clamp 26 is coupled to the jig base 102 such that movement of the jig base 102 keeps the clamps 26 in position and coupled to the jig base 102.

While clamp 26 has been described according to the arrangement shown, as one example, it will be understood by those skilled in the art that any other configuration of clamp 26 may be used in order to provide a motion preventing force to the base assembly 101 and the workpiece 12.

### Drill

With reference to the figures, a drill 38 is presented. Drill 38 may be any drill, such as, by way of example, a battery powered handheld drill. In the arrangement shown, as one example, the drill 38 is formed of any suitable size, shape, and design and is configured to provide the torque to a boring bit or other drill bit to cut away material from the workpiece 12 to allow the placement of concealed hinges and their corresponding fasteners.

In the arrangement shown, as one example, the drill 38 has a chuck 40, a chuck handle 42, and a drill handle 44. In the arrangement shown, as one example, the drill 38 is configured to accept a chuck fitting 236 of a square fitting assembly 204 within the chuck 40. The user then tightens the chuck fitting 236 within the chuck 40 by rotating the chuck handle 42 with respect to the chuck 40, thereby holding the drill bit tightly within the chuck 40 of the drill 38. In the arrangement shown, as one example, the drill 38 is configured to be held by a user on the drill handle 44, the user then operating the drill to rotate the chuck 40 and the square fitting assembly 204 while the jig assembly 100 aids the user in holding the drill handle 44 stationary. In this way both the concealed hinge bore and associated pilot holes may be cut into the workpiece 12 using the drill 38.

While drill 38 has been described according to the arrangement shown, as one example, it will be understood by those skilled in the art that any other configuration of drill 38 may be used in order to provide the torque necessary to drill holes in a workpiece.

### Jig Assembly

With reference to the figures, a jig assembly 100 is presented. In the arrangement shown, as one example, the jig assembly has a base assembly 101 and a bit guide assembly 200 removably and selectively coupled thereto. In the arrangement shown, as one example, the base assembly 101 is configured to locate and attach to the workpiece 12 and is held in place by clamps 26. In the arrangement shown, as one example, the bit guide assembly 200 is attached to the drill 38 and then is coupled to the correctly located base assembly 101 to create the concealed hinge bore and associated pilot holes for later attachment of the concealed hinge assembly (not shown) to the workpiece 12.

### Base Assembly

With reference to the figures, a base assembly 101 is presented. In the arrangement shown, as one example, the base assembly 101 has a base 102, one or more edge knobs 104, one or more stop block assemblies 106, and one or more pilot hole bushings 108. In the arrangement shown, the base assembly 101 is configured to provide a platform to adjustably and correctly locate the boring bit 208 on the workpiece 12 such that in use the boring bit 208 cuts one or more correctly located bores on the back surface 22 of the workpiece 12. In one or more arrangements, one or more edge knobs 104 are rotatably coupled to the base 102 such that the desired distance from the hinge side 16 of the workpiece is repeatably and accurately set. In one or more arrangements, one or more stop block assemblies 106 are slidably coupled to the base 102 such that the desired distance from the top and bottom 14 of the workpiece 12 is repeatably and accurately set. In the arrangement shown, as one example, one or more pilot hole bushings 108 are set into the base assembly 101 to repeatably and accurately drill pilot holes for the fasteners associated with the concealed hinge.

Base: With reference to the figures, a base 102 is presented. The base 102 is formed of any suitable size, shape, and design and is configured to provide a platform that rests stably on the workpiece 12 and allows a user to locate the bit guide assembly 200 repeatably and reliably on the workpiece 12 such that in use the boring bit 208 cuts one or more correctly located bores on the back surface 22 of the workpiece 12. In the arrangement shown, the base 102 has a top 110, a bottom surface 111, opposing left and right hand sides 112 (or simply “sides 112”), a front 114, a back 116 with ribs 118, and a top surface 120.

In the arrangement shown, as one example, the base 102 may be formed of a single, unitary member that is formed in a manufacturing process such as injection molding or the like to form a unitary and monolithic member. Base 102 may be formed of any number of non-metallic materials such as a wooden material, fiberglass, plastic, a composite material, or any other non-metallic material that is customary for use as a base for connecting other elements thereto.

In the arrangement shown, as one example, when viewed from top 110, base 102 is generally in the geometric shape of a rectangle with rounded corners, however base 102 may be formed of any other shape or configuration, including an obround, an oval, or any other shape. In the arrangement shown, as one example, the top 110 and the bottom 111 are in substantially parallel planar spaced relation to one another. In the arrangement shown, as one example, when viewed from the front 114 or the back 116 of the base 102, the base 102 is generally in the geometric shape of a flattened rectangle, much wider between the sides 112 than tall from bottom 111 to top 110. In the arrangement shown, as one example, when viewed from a left or right side 112, the base 102 is in the general geometric shape of a trapezoid, with parallel top 110 and bottom 111, and non-parallel front 114 and back 116, where the back 116 angles downwardly such that it is visible to a user when looking from the top 110.

In the arrangement shown, as one example, base 102 includes one or more clamp securing recesses 122. Clamp securing recesses 122 are formed of any suitable size, shape, and design, and are configured to facilitate the removable and slidable connection of clamp 26 to the base 102 such that the clamp 26 is out of the way of the drill 38 during use. In the arrangement shown, as one example, clamp securing recesses 122 are substantially rectangular recesses extending downwardly from the top surface 120 of the base 102. In the arrangement shown, as one example, the main axes of the clamp securing recesses 122 may be at a non-normal angles to the centerline of the base 102 and farther apart toward the front 114 of the base 102 than near the middle of the base 102. These non-normal angles provide stability to the base 102 that is clamped to the workpiece 12, while giving enough room for a user to hold and operate the drill 38 in the center of the base 102.

In the arrangement shown, as one example, the clamp securing recesses 122 include overhang flanges 124 on either side of the clamp securing recesses 122. In the arrangement shown, as one example, the overhang flanges 124 cooperate with a clamping surface flange 32 on the clamp 26, such that the clamp 26 remains attached to the base 102 when the clamp 26 is loosened. In this way, a user can move the base assembly 101 from location to location without having to reset the clamp 26 to the base 102 at every location. In the arrangement shown, as one example, the clamp securing recess 122 further includes an interference boss 126 that provides increased interference between the base 102 and the clamping surface 30 of the clamp 26, and further enhances the retention of the clamp 26 to the base 102.

In the arrangement shown, as one example, base 102 includes one or more stop block slots 128. Stop block slots 128 are formed of any suitable size, shape, and design, and are configured to facilitate the slidable connection of stop block assemblies 106 to the base 102. In the arrangement shown, as one example, stop block slots 128 are substantially obround openings in the base 102 that extend in a side-to-side direction, however stop block slots 128 may be formed of any other shape or configuration including a rectangle, an oval, or any other shape. In the arrangement shown, as one example, the main axes of the stop block slots 128 are parallel to the back 116 of the base 102. This allows the stop block assemblies 106 to slide within the stop block slots 128 to a desired location to locate the bore an accurate and repeatable distance from the top and bottom 14 of the workpiece 12.

In the arrangement shown, as one example, on the bottom 111 of base 102 at the stop block slots 128 are predetermined detents 130 (or “detents 130”). In the arrangement shown, as one example, the detents 130 are small cutouts on the bottom 111 of the base 102 that allow for easy locating of the stop block assembly 106 at locations that are frequently used in locating the bore on the workpiece 12. In the arrangement shown, as one example, a user slides the stop block assembly 106 until the locating flange 166 of the base 162 of the stop block assembly 106 rests within one of the detents 130 such that fine locating and/or measuring is unnecessary by the user.

In the arrangement shown, as one example, the base 102 includes a boring bit aperture 138 (or “bit aperture 138”). In the arrangement shown, as one example, the bit aperture 138 is substantially located in the middle of the base 102 and is a large enough opening to allow the boring bit 208 to pass through and return. In the arrangement shown, as one example, the bit aperture 138 is an unconventional shape that is symmetrical right to left, although the bit aperture 138 may be any unconventional shape or a conventional geometric shape including a circle, a rectangle, an oval, or any other shape to allow the boring bit 208 to pass through centered in the bit aperture center line 140 and include other locating elements therein.

In the arrangement shown, as one example, the bit aperture 138 may include bit guide assembly locating elements, namely a bit guide assembly locating surface 141 and bit guide assembly flanges 142. The bit guide assembly locating surface 141 may be formed of any suitable size, shape, and design and is configured to provide a stable base for and to set the height location of the bit guide assembly 200 on the base 102. In the arrangement shown, as one example, the bit guide assembly locating surface 141 is a circular and planar surface about the bit aperture 138 parallel to and set downwardly from the top surface 120 that locates the bit guide 202 at the proper height to ensure a proper depth of bore in the workpiece 12.

In the arrangement shown, as one example, about the bit guide assembly locating surface 141 are one or more bit guide assembly flanges 142. The bit guide flanges are formed of any suitable size, shape, and design to facilitate the selective attachment of the bit guide assembly 200 to the base 102. In the arrangement shown, as one example, the bit guide assembly flanges 142 selectively allow the bit guide assembly 200 to rest on the bit guide assembly locating surface 141 and hold the bit guide assembly 200 in place when the bit guide assembly 200 is rotated by the user.

In the arrangement shown, as one example, the bit aperture 138 includes pilot hole bushing guides 144. The pilot hole bushing guides 144 are formed of any suitable size, shape, and design, and are configured to facilitate the location of the pilot hole bushings 108 about the bit aperture 138. In the arrangement shown, as one example, the pilot hole bushing guides 144 are in the geometric shape of an obround and are located within the perimeter of the bit guide assembly locating surface 141, however the pilot hole bushing guides 144 may be formed of any other shape or configuration including a rectangle, an oval, or any other shape that allow pilot hole bushings to be selectively attached and detached to and from the base 102.

In the arrangement shown, as one example, the base 102 includes indicia 146 on the top surface 120 adjacent to the back 116 of the base 102. The indicia 146 are formed of any suitable size, shape, and configuration to facilitate the location of the base assembly 101 from the top and bottom 14 of the workpiece 12. In the arrangement shown, as one example, the indicia 146 are molded into the top surface 120 of the base 102 and include measurements that start at “0” at center line of the boring bit aperture 138, and extend in either side-to-side direction to facilitate measurement of the center line of the bit aperture 138 from the top and bottom 14 of the workpiece 12. In other arrangements, the indicia 146 include both imperial and metric measurements and/or are placed on the top surface 120 by painting, a sticker, or any other method to indicate to a user the distance from the top and/or the bottom 14 of the workpiece 12 to the centerline of the bit aperture 138.

While base 102 has been described according to the arrangement shown, as one example, it will be understood by those skilled in the art that any other configuration of base 102 may be used in order to provide a stable surface from which to locate a boring bit.

Edge Knobs. With reference to the figures, edge knobs 104 are presented. The edge knobs 104 are formed of any suitable size, shape, and design and are configured to locate the base assembly 101 at a desired distance from the hinge side 16 of the workpiece 12. In the arrangement shown, the edge knobs 104 are substantially cylindrical in the vertical direction and include a handle 148, a locating flange 150, clips 152, locating surface 154, a center axis 156, and indicia 158.

In the arrangement shown, as one example, the edge knobs 104 may be formed of a single, unitary member that is formed in a manufacturing process such as injection molding or the like to form a unitary and monolithic member. Edge knobs 104 may be formed of any number of a non-metallic materials such as wooden material, fiberglass, plastic, a composite material, or any other non-metallic or metallic material that is customary for use as a replaceable, locatable, and rotatable knob that is useable by hand and without the use of tools.

In the arrangement shown, as one example, when viewed from top 110 of base 102, the locating flange 150 of edge knobs 104 are generally in the geometric shape of a circle, however edge knobs 104 may be formed of any other shape or configuration, including a rectangle, and a round, an oval, or any other shape. In the arrangement shown, as one example, when viewed from a side, edge knobs 104 form an irregular shape or configuration that is suitable to allow a user to easily rotate the edge knobs 104 to locate the base assembly 101 the desired distance from a hinge side 16 of the workpiece 12.

In the arrangement shown, as one example, edge knobs 104 include a handle 148 extending upwardly from locating flange 150. In the arrangement shown, as one example, when viewed from the top, handle 148 is in the general geometric shape of a rounded rectangle, although handle 148 could be any other geometric shape such as an oval, and obround, or any other geometric shape that allows the user to grab and twist the edge knobs 104.

In the arrangement shown, as one example, edge knobs 104 include elements extending downwardly from the perimeter of the locating flange 150 that allow the edge knob 104 to be held in place as well as located within edge knob holes 132 of the base 102. In the arrangement shown, as one example, these elements include clips 152 and locators 160.

In the arrangement shown, as one example, each clip 152 includes a tooth that is able to deflect out of the way when the edge knob 104 is inserted into the base 102, and snap outwardly such that the edge knob 104 is held to the base 102 when fully inserted. In other arrangements, any other type of clip may be used to hold the edge knob 104 to the base 102.

In the arrangement shown, as one example, locator 160 includes a rounded tooth that interfaces with predetermined detent 136 of the edge knob hole 132 on the base 102. In the arrangement shown, as one example, the locator 160 is able to slide in and out of predetermined detent 136 such that a user may choose the distance from the side of the workpiece 12 using the indicia 158 on the top of the locating flange 150 of the edge knob 104.

In the arrangement shown, as one example, edge knobs 104 includes at least one locating surface 154 extending downwardly from locating flange 150 located at varying distances from the center line 156 of the edge knob 104. In the arrangement shown, as one example, locating surfaces 154 cooperate with locator 160 and predetermined detents 136 to provide an easy and repeatable surface for a user to locate the base assembly 101 a desired distance from the hinge side 16 of the workpiece 12. In the arrangement shown, as one example, locating surfaces 154 are generally planar surfaces that provide for a stable surface to rest against the side of the workpiece 12 when locating the base assembly 101 on the workpiece 12. In other arrangements, locating surface 154 may be a spiraling cylindrical shape, with the distance of the surface 154 to the center axis 156 of edge knob 104 at appropriate distances based on the position of the edge knob 104 within the base 102.

While edge knob 104 has been described according to the arrangement shown, as one example, it will be understood by those skilled in the art that any other configuration of edge knob 104 may be used in order to provide easily changeable and reliable method of setting a bore distance from a hinge side 16 of a workpiece 12.

Stop Block Assembly. In the arrangement shown, as one example, base assembly 101 includes one or more stop block assemblies 106 configured to easily and repeatably locate the base assembly 101 at desired predetermined distances from the top and bottom 14 of the workpiece 12. In the arrangement shown, as one example, stop block assembly 106 is formed of any suitable size, shape, and design and is configured to provide an easy and repeatable method for a user to locate the base assembly 101 at desired predetermined distances from the top and/or bottom 14 of the workpiece 12.

In the arrangement shown, as one example, stop block assembly 106 is formed of a stop block base assembly 171 and a set screw assembly 182. In the arrangement shown, as one example, the set screw assembly 182 is coupled to the stop block base assembly 171 to selectively tighten and loosen the stop block assembly 106 within the stop block slots 128 of the base 102 for location and relocation of the stop block assembly 106 within stop block slot 128.

In the arrangement shown, as one example, the stop block base assembly 171 includes a base 162, a threaded hole 164, locating flange 166, set screw flange 168, and a spring flange 170. In the arrangement shown, as one example, the base 162 is a generally rectangular shape when viewed from the top and spring flange 170 extends outwardly from the perimeter of the base 162 along one side of the base 162. In the arrangement shown, as one example, there are two stop block assemblies 106 attached to the base 102 and are mirror images of one another, including right hand and left hand side stop block base assemblies 171. In other arrangements the stop block base assemblies 171 may be symmetrical such that stop block base assemblies 171 may be interchangeable from the right hand side to the left hand side. In still other arrangements, the same stop block assembly 106 may be used on either side of the base 102 by simply using the opposite side of stop block 172 as the stop surface 180.

In the arrangement shown, as one example, threaded hole 164 extends through the base 162 and is offset to one side of the base 162 when viewing from the top. In other arrangements, spring flange 170 and threaded hole 164 may be located in any suitable location on or around the base 162 of the stop block assembly 106, such as symmetrically positioned about a center line of the base 162.

In the arrangement shown, as one example, stop block assembly 106 includes a stop block 172 rotatably coupled to the base 162 which includes a spring flange recess 176 such that the stop block 172 is able to surround the spring flange 170 when the stop block 172 is not in use on the workpiece 12. In the arrangement shown, as one example, the stop block 172 rotates downwardly from the base 162 such that the stop surface 180 of the stop block 172 is able to interface with the workpiece 12 when in use, and rotate upwardly and not interface with the workpiece 12 when not in use. In the arrangement shown, as one example, the stop block 172 is urged into the interface position by a spring 174 that fits within a spring boss 178 on the stop block 172. The other end of spring 174 is fixed against a bottom side of the spring flange 170 which offers the base for spring 174 to supply the downward force on the stop block 172 to urge the stop block 172 into the interface position.

In the arrangement shown, as one example, about the threaded hole 164 on the top side of the base 162 are arranged a pair of locating flanges 166 and set screw flanges 168. Locating flange 166 is formed of any suitable size, shape, and design and is configured to correspond with predetermined detents 130 within stop block slots 128 on the base 102. In the arrangement shown, as one example, the locating flanges 166 are of similar size and shape and fit within the predetermined detents 130 within stop block slots 128 such that predetermined locations of the base assembly 101 on the workpiece 12 are easily and repeatably located by the user. In the arrangement shown, as one example, locating flanges 166 of the stop block assemblies 106 are generally rectangular in shape and have a thickness that corresponds with the width of the predetermined detents 130 within stop block slots 128. In other arrangements, the size, shape, and design of locating flanges 166 maybe any suitable size, shape, and configuration to correspond with predetermined detents 130 within stop block slots 128 such as round, oval, triangular, or any other geometric shape.

In the arrangement shown, as one example, set screw flange 168 may be any suitable size, shape, and design to interface with locating flange 190 of set screw assembly 182, and is in the general geometric shape of a rectangle. In the arrangement shown, as one example, the thickness of set screw flange 168 corresponds with the locating flange gap 192 of the locating flange 190 on set screw assembly 182. In other arrangements, set screw flange 168 may be any suitable size, shape, or design to interface with the set screw assembly 182 and allow for accurate location of the stop block assembly 106 on the base 102 for easy and repeatable location of the base assembly 101 on the workpiece 12.

In the arrangement shown, as one example, set screw assembly 182 may be any suitable size, shape, and design and is configured to allow a user to selectively tighten and loosen stop block base assembly 171 on base 102 for the desired location of the base assembly 101 on the workpiece 12. In the arrangement shown, as one example, set screw assembly 182 includes a handle 184, a stud 186, locating surface 188, locating flange 190, and the locating flange gap 192.

In the arrangement shown, as one example, the stop block base assembly 171 is placed on an underside of the base 102 and the set screw assembly 182 is coupled to the stop block base assembly 171 from the top of the base 102. In the arrangement shown, as one example, the set screw assembly stud 186 is threaded into the threaded hole 164 within the stop block base 162. In the arrangement shown, as one example, as the stud 186 is rotated into the threaded hole 164 by a user twisting the set screw handle 184, edges of the locating flange 190 are brought into contact with edges of the stop block slots 128, and the set screw flange 168 of the stop block base assembly 171 is brought into contact and corresponds to the locating flange gap 192 defined by locating flange 190. In the arrangement shown, as one example, locating surface 188 contacts top surface 120 of base 102 when the set screw assembly 182 is fully tightened to the stop block base assembly 171.

While stop block assembly 106 has been described according to the arrangement shown, as one example, it will be understood by those skilled in the art that any other configuration of stop block assembly 106 may be used in order to provide easily changeable and reliable method of setting a bore distance from the top and bottom 14 of a workpiece 12.

Pilot Hole Bushing. With reference to the figures, a pilot hole bushing 108 is presented. The pilot hole bushing 108 is formed of any suitable size, shape, and design and is configured to provide a predetermined depth and location of pilot holes drilled for concealed hinges. In the arrangement shown, as one example, the pilot hole bushing 108 includes top and bottom surfaces 194, an exterior surface 196, and one or more pilot hole apertures 198 extending through the pilot hole bushing 108.

In the arrangement shown, as one example, the pilot hole bushing 108 may be formed of a single, unitary member that is formed in a manufacturing process such as injection molding or the like to form a unitary and monolithic member. Pilot hole bushing 108 may be formed of any number of metallic or non metallic materials such as wooden material, fiberglass, plastic, a composite material, steel, aluminum, or any other metallic or non metallic material that is customary for use as guide for drilling into a workpiece.

In the arrangement shown, as one example, pilot hole bushing 108 is generally in the shape of an obround when viewed from the top, however pilot hole bushing 108 may be formed of any other shape or configuration, including a circle, an oval, or any other shape that corresponds to pilot hole guide 144 within the base 102. In the arrangement shown, as one example, top and bottom surfaces 194 are in substantially parallel planar spaced relation to one another. In the arrangement shown, as one example, when viewed from the front or back, the pilot hole bushing 108 is generally in the shape of a rectangle having a height that provides for the proper depth of drilling for a user for a pilot hole to enter into but not through the workpiece 12. In other arrangements, pilot hole bushing 108 may be formed of any other shape or configuration that provides for the depth for pilot hole drilling desired by a user.

In the arrangement shown, as one example, pilot hole apertures 198 are generally cylindrical apertures through the pilot hole bushing 108 and extending between the top and bottom 194 of the pilot hole bushing 108. In the arrangement shown, as one example, there are four pilot hole apertures 198 located at different locations in the top and bottom of pilot hole bushing 108, which allow for 8 locations for pilot holes by flipping the pilot hole bushing 108 within pilot hole guide 144 of the base 102. In other arrangements, fewer or more pilot hole apertures 198 may be located in fewer or more locations within pilot hole bushing 108 to allow for fewer or more locations for pilot holes into workpiece 12.

While pilot hole bushing 108 has been described according to the arrangement shown, as one example, it will be understood by those skilled in the art that any other configuration of pilot hole bushing 108 may be used in order to provide easily interchangeable bushing to guide pilot hole drilling into a workpiece 12.

### Bit Guide Assembly

With reference to the figures, a bit guide assembly 200 is presented. In the arrangement shown, as one example, the bit guide assembly 200 is any suitable size, shape and design and includes a bit guide 202, a square fitting assembly 204, a stop collar 206, a boring bit 208, and a spring 210. In the arrangement shown, the bit guide assembly 200 is configured to provide an easy and repeatable connection to the drill 38 and the base assembly 101 and easily and quickly provide for removal of the boring bit 208 for exposure of the drill bit 262 to drill pilot holes.

Bit Guide: with reference to the figures, a bit guide 202 is presented. The bit guide 202 is formed of any suitable size, shape, and design and is configured to attach and detach from the base assembly 101 quickly and easily, while providing proper location for the boring bit 208. In the arrangement shown, as one example, when viewed from the top of the jig assembly 100, the bit guide 202 is in the general geometric shape of a circle with stanchions 220 (in the arrangement shown, as an example, 3 stanchions 220) extending outwardly from a center bit collar 214 out to an outer base attachment ring 228.

In the arrangement shown, as one example, the bit guide 202 may be formed of a single, unitary member that is formed in a manufacturing process such as injection molding or the like to form a unitary and monolithic member. Bit guide 202 may be formed of any number of non metallic materials such as wooden material, fiberglass, plastic, a composite material, or any other non metallic material that is customary for use as a bit guide.

In the arrangement shown, as one example, the guide cylinder 212 and the base attachment ring 228 are generally in the geometric shape of a circle and share a common center axis. Base attachment ring 228 has a bottom surface 230 that is generally planar and corresponds to bit guide assembly surface 141 on the base 102. Extending outwardly from the base attachment ring 228 are one or more retention flanges 232 that slidably couple with bit guide assembly flanges 142 on the base 102. The bit guide 202 is rotated such that the retention flanges 232 interface increasingly with the bit guide assembly flanges 142 on the base 102 until the retention stops 234 interfere with the bit guide assembly flanges 142 and prevent further rotation.

In the arrangement shown, as one example, stanchions 220 extend upwardly from base attachment ring 228 and curve inwardly to provide a solid base for the guide cylinder 212. Stanchions 220 are formed of any suitable size, shape, and design and are configured to provide strength and stability to the guide cylinder 212. In the arrangement shown, as one example, when viewed from the side of the jig assembly 100 the stanchions 220 may resemble the top half of the letter C, extending vertically upward from the base attachment ring 228, extending horizontally away from guide cylinder 212, and having a rounded connection between these two extensions. Stanchions 220 may include sides 222, top surface 224, bottom 226, and ribs 227. In the arrangement shown, as one example, one or more ribs 227 are disposed on the underside of stanchion 220 and may provide more strength to the stanchions 220 to oppose the forces imposed on the bit guide assembly 200 by a user drilling a bore in the back of workpiece 12.

In the arrangement shown, as one example, guide cylinder 212 is formed of any suitable size, shape, and design and is configured to guide the boring bit 208 in the proper orientation and to the proper depth that a user desires. In the arrangement shown, as one example, when viewed from the top the guide cylinder 212 is in the geometric form of a circle and reaches from a top spring surface 216 downwardly to a bottom 218 of the guide cylinder 212. In some arrangements, the guide cylinder 212 is formed integrally with the bit guide 202 as part of an injection molded process. In still other arrangements, the guide cylinder 212 may be a separate piece, formed of a metallic material such as aluminum or any other metallic substance, and attached to the bit guide 202 using fasteners, adhesives, welding, or any other method known in the art to attach a separate bit collar 214 to the bit guide 202, or within a guide cylinder 212 of the bit guide 202.

In the arrangement shown, as one example, underneath the bottom 218 of the guide cylinder 212 and inboard of base attachment ring 228 is an empty space 221. Empty space 221 maybe any suitable size shape and design and is configured to provide a space for the boring bit 208 to be held in a non-contact position above the workpiece 12.

Square Fitting Assembly: With reference to the figures, a square fitting assembly 204 is presented. The square fitting 204 is formed of any suitable size, shape, and design and is configured to easily attach and detach a drill bit 262 from stop collar 206. In the arrangement shown, as one example, the square fitting assembly 204 has a chuck fitting 236, a main cylinder 242, a square fitting 248, a top locating surface 250, and a drill bit 262.

In the arrangement shown, as one example, square fitting assembly 204, other than the drill bit 262, may be formed of a single, unitary member that is formed in a manufacturing process such as casting or the like to form a unitary and monolithic member, that a drill bit 262 is then attached to. Square fitting assembly 204 may be formed of any number of metallic materials such as aluminum or steel, or any other metallic material suitable for the processes described herein.

In the arrangement shown, as one example, when viewed from the top the square fitting assembly 204 has the general shape of a circle, however square fitting assembly 204 may be formed of any other shape or configuration, including a square, hex, or any other shape. In the arrangement shown, as one example, a chuck fitting 236 extends upwardly from a top locating surface 250 of the square fitting assembly 204. The chuck fitting 236 when viewed from the top has the geometric shape of a hexagon comprising torquing surfaces 238 which is interrupted at a fitting detent 240 configured to securely hold the square fitting assembly 204 within the chuck 40 of the drill 38. However, chuck fitting 236 may be formed of any other shape or configuration, including a square or any other shape that allows for fitting into the chuck 40 of the drill 38 and allows for torque to be transferred from the drill 38 to the square fitting assembly 204.

In the arrangement shown, as one example, the main cylinder 242 of square fitting assembly 204 extends downwardly from the top locating surface 250. The main cylinder 242 includes a threaded screw hole 244 within which a set screw 246 is inserted to hold the drill bit 262 in place when inserted into the square fitting assembly 204. In the arrangement shown, as one example, square fitting 248 it is on the lower portion of the main cylinder 242 and includes torquing surfaces 252. Torquing surfaces 252 are generally planar surfaces with adjacent torquing surfaces 252 on a plane normal to one another, and torquing surfaces 252 on opposite sides of the main cylinder 242 parallel to one another. Torquing surfaces 252 are joined by rounded corners 256 which allow for some manufacturing tolerance in the square fitting recess 268 of this stop collar 206. In the arrangement shown, as one example, one or more torquing surfaces 252 include a ball detent hole 254 to receive a ball detent 270 from the stop collar 206.

In the arrangement shown, as one example, on a downwardly facing face of the square fitting 248 is a drill bit hole 258 that reaches up into the main cylinder 242 of the square fitting assembly 204. The drill bit hole 258 extends upwardly at least to the threaded screw hole 244 in the main cylinder 242 of square fitting assembly 204 and ends at bit stop locating surface 260. The drill bit hole 258 is configured to accept a drill bit 262 to be inserted into the drill bit hole 258 such that a drill bit head 264 may be held securely in place within the square fitting assembly 204 by tightening the set screw 246 within the threaded screw hole 244 and against the drill bit head 264, while leaving the drill bit cutting portion 266 exposed and extending downwardly from the square fitting assembly 204.

Stop Collar: with reference to the figures, a stop collar 206 is presented. The stop collar 206 is formed of any suitable size, shape, and design and is configured to easily attach and detach a boring bit 208 to the square fitting assembly 204 for quick and easy change from the boring bit 208 to the drill bit 262 depending on the desired hole the user would like to cut in the workpiece 12. In the arrangement shown, as one example, the stop collar 206 has a square fitting recess 268, a ball detent 270, a ball detent aperture 272, a threaded screw hole 274, an exterior surface 280, and a top 278, an interior 282, and a bottom spring surface 284.

In the arrangement shown, as one example, stop collar 206 may be formed of a single, unitary member that is formed in a manufacturing process such as casting or the like to form a unitary and monolithic member. Stop collar 206 may be formed of any number of metallic materials such as aluminum or steel, or any other metallic material suitable for the processes described herein.

In the arrangement shown, as one example, stop collar 206 has the general geometric shape of a circular cylinder, however stop collar 206 may be formed of any other shape or configuration, including a square cylinder, a hex cylinder, a triangle cylinder, or any other shape that is known.

In the arrangement shown, as one example, stock collar 206 includes a square fitting recess 268 formed into the top 278 of the stop collar 206. The square fitting recess 268 corresponds to square fitting 248 of the square fitting assembly 204, and includes torquing surfaces that correspond to torquing surfaces 252 of the square fitting 248. The square fitting recess 268 includes a ball detent aperture 272 within which is placed a ball detent 270 which corresponds to ball detent holes 254 of the square fitting assembly 204 when assembled. In the arrangement shown, as one example, ball detent 270 will extend a short distance into the square fitting recess 268 and then into ball detent holes 254 of the square fitting assembly 204 holding the square fitting assembly 204 within the stop collar 206.

In the arrangement shown, as one example, below the square fitting recess 268 is a hollow interior 282 of the stop collar 206, within which the shaft 286 or hollow throat 286 of boring bit 208 and the drill bit 262 reside when the square fitting assembly 204 is assembled to the stop collar 206. Extending through the exterior surface 280 and into the interior 282 of the stop collar 206 near the bottom of the stop collar 206 is a threaded set screw hole 274 configured to accept a set screw 276 to hold the boring bit 208 in place when assembled to the stop collar 206. In the arrangement shown, as one example, at the bottom of the stop collar 206 is a downwardly facing bottom spring surface 284, which provides a surface for the spring 210 to push upwardly against and urge the bit guide assembly 200 upward in the absence of any force against the urging of the spring 210.

In other arrangements, the stop collar 206 may be longer to accommodate a boring bit 208 that does not include a hollow shaft. In this arrangement, the stop collar 206 may function in the same way as described above, but may be any length that allows the drill bit 262 to reside within the hollow interior of the stop collar 206 without coming into contact with the boring bit 208. In this way, the square fitting assembly 204, drill bit 262, and stop collar 206 may be used with any boring bit 208 having a sold shaft or a hollow throat 286.

Boring Bit: With reference to the figures, a boring bit 208 is presented. The boring bit 208 is formed of any suitable size, shape, and design and is configured to cut a bore into a workpiece 12, attach to the stop collar 206, and house the drill bit 262 when not in use. In the arrangement shown, as one example, the boring bit 208 includes a hollow throat 286, an exterior 288, an interior 290, a torquing face 292, a top locating surface 294, a chipper 296, a cutting edge 297, and a center spur 298.

In the arrangement shown, as one example, the boring bit 208 is in the general shape of a circular cylinder having two different diameters. The hollow throat 286 is generally a long, skinny cylinder having a diameter much smaller than its length, while the chipper 296 is a short and wider cylinder having a diameter much larger than its length. However, the boring bit 208 may be formed of any other shape or configuration that allows for attachment to the stop collar 206 and for cutting a bore into a workpiece 12.

In the arrangement shown, as one example, the top of the boring bit 208 includes a top locating surface 294 which is located within stop collar 206 and sets the depth of the cutting edge 297 on the chipper 296. Extending downwardly from top locating surface 294 is a fitting that includes a torquing face 292 that corresponds to set screw 276 in the stop collar 206 such that when the set screw 276 is tightened within threaded set screw hole 274 within the stop collar 206 the boring bit 208 is held tightly in place within the stop collar 206. In the arrangement shown, as one example, a hollow interior 290 extends downwardly from top locating surface 294 and into the hollow throat 286 of the boring bit 208, such that the drill bit 262 resides within the interior 290 of the boring bit 208 when bit guide assembly 200 is fully assembled.

In the arrangement shown, as one example, the boring bit 208 terminates in a boring cutter which includes chipper 296, cutting edge 297, and center spur 298. The chipper 296, cutting edge 297, and center spur 298 operate in their normal and typical manner on any boring bit known in the art.

### In Operation

In the arrangement shown, as one example, jig assembly 100 may be operated by a user to reliably and repeatably cut concealed hinge bores in the back of a workpiece 12. First, a user provides a drill 38, commonly a handheld electric drill, a workpiece 12, typically a covered door or the like, and the jig assembly 100, with the base assembly 101 and the bit guide assembly 200 separated.

To begin, a user typically will attach the base assembly 101 to the workpiece 12. To do this, the user will flip the workpiece 12 such that the back surface 22 is facing upwardly, or toward the user. The user will then identify which side of the workpiece 12 is the hinge side 16 and which side is the handle side 18, and orient the hinge side 16 closer to the user. The user will then identify the distance from the edge of the workpiece 12 on the hinge side 16 that the bore and pilot holes need to be for proper alignment of the concealed hinge on the workpiece 12. The user will then rotate the edge knobs 104 to the proper distance using the indicia 158 on top of edge knobs 104.

The user will then identify the distance from the top and bottom 14 of the workpiece 12 that the bore and pilot holes need to be for proper alignment of the concealed hinge on the workpiece 12. The user will then loosen handle 184 of set screw assembly 182 of stop block assembly 106 and slide within stop block slots 128 to the proper shown distance on the indicia 146 associated with the stop block assemblies 106 on the top of the base 102. This will place the distance d from the center of the bit aperture 138 to the stop surface 180 of the stop block 172 at the distance shown on the indicia 146.

While one of the stop block assemblies 106 is used in the location of the base assembly 101 on the workpiece 12 at a time, the other stop block is rotated upwardly and flush with the bottom 111 of base 102 such that it is completely unused. If the base assembly 101 is slid to the other side 14 of the workpiece 12, both stop blocks 172 are flush with the bottom 111 of base 102 until one of the stop block assemblies 106 loses contact with the workpiece 12 and the spring 174 of the stop block assembly 106 urges the stop block 172 downwardly, exposing stop surface 180, and can be used for location on that side of base assembly 101.

Alternatively, the user can use the indicia 146 at the top of the base 102 to locate the center line of the bit aperture 138, and by extension the boring bit 208, from the top and bottom 14 of the workpiece 12 and move stop block assemblies 106 against the top or bottom 14 of the workpiece 12 to match the measured distance on indicia 146 on the base 102. When this is complete for either the top or bottom 14 of the workpiece 12, the user can either use the set screw indicia on the top of the base 102 to set the other set screw assembly, or repeat the process again when moving to the other of the top or bottom 14 of the workpiece 12.

The user may then hold the base assembly 101 in place securely by attaching clamps 26 by sliding clamping surface 30 and clamping surface flange 32 into the clamp securing recess 122 on base 102. The slidable handle 28 of clamp 26 may then be slid into soft contact with the workpiece 12, and then tightened to securely hold the base assembly 101 in the desired location on workpiece 12. When moving to the other of the top or bottom 14 of the workpiece 12 the clamps 26 may be held in place on the base 102 in the clamp securing recess 122 by the interference of the overhang flange 124 and clamping surface flange 32 such that the clamps 26 remain in place when moving to the other side. In this way, the user does not need to remove clamps 26 from the jig assembly 100 each and every time the jig assembly 100 is relocated for another cut.

The user will then attach the bit guide assembly 200 to the drill 38 by inserting the chuck fitting 236 into the chuck 40 of the drill 38, and tightening the chuck 40 by rotating the chuck handle 42 until tight. The user will then place the base attachment ring 228 onto the bit guide assembly surface 141 such that the retention flange 232 do not interfere with bit guide assembly flanges 142, and the bottom surface 230 of base attachment ring 228 rests on bit guide assembly surface 141. The user will then rotate the bit guide 202 such that retention flanges 232 slide underneath bit guide assembly flanges 142 until the retention stops 234 come into contact with the ends of bit guide assembly flanges 142. Spring 210 urges the bit guide 202 at top spring surface 216 and the stop collar 206 at bottom spring surface 284 apart which holds the boring bit 208 upwardly in a non-contact position such that the center spur 298 and cutting edge 297 do not come into contact with the workpiece 12 prematurely to prevent unwanted scratches on the workpiece 12.

To cut the bore into the workpiece 12, the user then operates the drill 38 which spins the boring bit 208 and pushes downwardly into the workpiece 12 until the bottom of the stop collar 206 abuts the top of guide cylinder 212 and prevents the boring bit 208 from advancing any deeper into workpiece 12. When the cut is complete, the user releases downward pressure on the drill 38 and the spring 210 urges the boring bit 208 upwardly and out of contact with the workpiece 12.

To drill pilot holes in their proper locations about the concealed hinge bore, the bit guide assembly 200 is rotated in the opposite direction from installation such that the retention flanges 232 are no longer in interference with bit guide assembly flanges 142, and bit guide assembly 200 may be removed from base assembly 101. Either at this time or before bit guide assembly 200 is attached to base assembly 101, pilot hole bushings 108 are placed into pilot hole guides 144 on base 102. At this time, this square fitting assembly 204 may be removed from the rest of the bit guide assembly 200 by simply pulling it out of stop collar 206, and overcoming the retention force of the ball detent 270 within stop collar 206 against ball detent holes 254 of the square fitting assembly 204. The bit guide 202, stop collar 206, boring bit 208, and spring 210 may be placed aside, and the now exposed drill bit 262 may be used within pilot hole apertures 198 of pilot hole bushing 108 in the appropriate location for the given concealed hinge used on the workpiece 12.

With one set of pilot holes and concealed hinge bore cut, the user may loosen clamps 26 and repeat the process to locate the base assembly 101 as described above for another set of pilot holes and concealed hinge bore. To reassemble the bit guide assembly 200, the square fitting 248 of the square fitting assembly 204 is simply placed within the square fitting recess 268 of stop collar 206 until the ball detent 270 reaches ball detent holes 254 in the torquing surfaces 252. In this way, the user need not detach or reattach any drill bits into and or out of the drill, reducing the time needed to complete the processes dramatically.

From the above discussion it will be appreciated that the system 10 presented herein improves upon the state of the art. Specifically, in one or more arrangements, a concealed hinge boring assembly is presented which: improves upon the state of the art; is safe to operate; is easy to attach and detach from a workpiece; is relatively friendly to use; which can be attached and detached from a workpiece and/or a drill quickly and efficiently; is easy to operate; is relatively cost friendly to manufacture; is relatively easy to transport; is aesthetically appealing; is robust; is relatively inexpensive; is not easily susceptible to wear and tear; has a long useful life; and/or is efficient to use and operate.

What is claimed:

1. A jig for cutting a pocket on a hinge side of a workpiece, the jig comprising:
a base;
a drill bit;
the drill bit operably connected to the base;
the drill bit configured to move between a non-contact position with the workpiece and a contact position with the workpiece;
the drill bit having a shaft;
the drill bit having a chipper having a first diameter;
the drill bit having a pilot hole drill bit assembly having a second diameter;
wherein the second diameter is smaller than the first diameter.

2. The jig of claim 1 wherein the chipper is a forstner bit.

3. The jig of claim 1 wherein the pilot hole drill bit assembly connects to an upper end of the shaft of the drill bit.

4. The jig of claim 1 wherein the pilot hole drill bit assembly connects to the shaft of the drill bit by way of a friction fit connection.

5. The jig of claim 1 wherein the pilot hole drill bit assembly connects to the shaft of the drill bit by way of a spring detent connection.

6. The jig of claim 1 wherein the pilot hole drill bit assembly connects to the shaft of the drill bit by way of a ball detent connection.

7. The jig of claim 1 wherein the pilot hole drill bit assembly extends within the shaft of the drill bit.

8. The jig of claim 1, wherein the pilot hole drill bit assembly is configured to connect to and be removable from the chipper.

9. The jig of claim 1, further comprising a bit guide;
the bit guide connected to the shaft of the drill bit;
the bit guide configured to removably connect the drill bit to the base.

10. The jig of claim 1 further comprising a bit guide and a spring;
wherein the bit guide is connected to the shaft of the drill bit;
wherein the spring is positioned around the shaft of the drill bit;
wherein the spring is configured to urge the drill bit into a non-contact position.

11. The jig of claim 1 further comprising a bit guide and a spring;
wherein the bit guide is connected to the shaft of the drill bit;
wherein the spring is positioned around the shaft of the drill bit;
wherein the spring is configured to urge the drill bit into a non-contact position;
wherein the drill bit is in the non-contact position when the chipper is above a bottom surface of the base and not in contact with a workpiece.

12. A chipper drill bit comprising:
a chipper and a shaft;
the chipper having a first diameter;
a coupler connected to the shaft of the chipper drill bit;
the coupler having a hollow interior;
a pilot hole drill bit assembly;
the pilot hole drill bit assembly having a pilot hole drill bit and a shaft;
the pilot hole drill bit having a second diameter, wherein the second diameter is smaller than the first diameter;
wherein the pilot hole drill bit assembly is configured to connect to and be removed from the coupler.

13. The drill bit of claim 12, wherein the pilot hole drill bit assembly connects to the coupler by way of a friction fit connection.

14. The drill bit of claim 12, wherein the pilot hole drill bit assembly connects to the coupler by way of a spring detent connection.

15. The drill bit of claim 12, wherein the pilot hole drill bit assembly connects to the coupler by way of a ball detent connection.

16. The drill bit of claim 12, further comprising a spring configured to hold the chipper in a non-contact position above a workpiece.

17. The drill bit of claim 12, wherein the pilot hole drill bit assembly is positioned at least partially within a hollow portion of the shaft of the chipper drill bit.

18. A drill bit for cutting a bore and associated pilot holes for a concealed hinge, the drill bit comprising:
a shaft;
the shaft having a hollow portion;
a chipper having a first diameter;
a pilot hole drill bit assembly having a second diameter;
wherein the second diameter is smaller than the first diameter;
the pilot hole drill bit assembly coupled to an upper end of the shaft of the drill bit;
wherein the pilot hole drill bit assembly is selectively removable from the hollow portion of the shaft.

19. The drill bit of claim 18 wherein the pilot hole drill bit assembly connects to the shaft of the drill bit by way of a friction fit connection.

20. The drill bit of claim 18 wherein the pilot hole drill bit assembly connects to the shaft of the drill bit by way of a spring detent connection.

21. The drill bit of claim 18 wherein the pilot hole drill bit assembly connects to the shaft of the drill bit by way of a ball detent connection.

22. The drill bit of claim 18, wherein the hollow portion of the shaft is configured to accept connection of a bit guide.

23. The drill bit of claim 18, wherein the hollow portion of the shaft is configured to accept connection of a bit guide and a stop collar.

24. The drill bit of claim 18, wherein the hollow portion of the shaft is configured to accept connection of a bit guide and a stop collar;
wherein a spring is configured to hold the chipper in a non-contact position above a workpiece.

25. The drill bit of claim 18, wherein the hollow portion of the shaft is configured to accept connection of a bit guide and a stop collar;
further comprising a spring between the bit guide and the stop collar, the spring configured to hold the chipper in a non-contact position above a workpiece.

26. The drill bit of claim 18 wherein the pilot hole drill bit assembly is positioned at least partially within the hollow portion of the shaft.

27. A jig for locating and guiding a cutting bit to cut a pocket on a hinge side of a workpiece, the jig comprising:
a base having a bit aperture configured to allow a cutting bit therethrough;
a cutting bit having a shaft and a chipper at one end of the shaft;
a bit guide removably coupled to the base;
the bit guide configured to guide the cutting bit;
a spring coupled to the cutting bit;
the spring configured to urge the cutting bit into a non-contact position.

28. The jig of claim 27 wherein the non-contact position is above a bottom surface of the base and not in contact with a workpiece.

29. The jig of claim 27 wherein the shaft of the cutting bit slidably located within a guide cylinder of the bit guide.

30. The jig of claim 27 wherein the spring pushes against the bit guide to urge the cutting bit into the non-contact position.

31. The jig of claim 27 further comprising a stop collar coupled to the shaft on an end of the shaft opposite from the chipper, the stop collar having a bottom spring surface.

32. The jig of claim 27 further comprising a stop collar coupled to the shaft on an end of the shaft opposite from the chipper, the stop collar having a bottom spring surface;
wherein the spring pushes against the bit guide and the bottom spring surface to urge the cutting bit into the non-contact position.

33. A jig for locating and guiding a cutting bit to cut a pocket on a hinge side of a workpiece, the jig comprising:
a base having a bit aperture configured to allow a cutting bit therethrough;
a bit guide removably coupled to the base and having a guide cylinder, wherein the guide cylinder has a top spring surface;
a cutting bit having a shaft and a chipper at one end of the shaft;
the shaft of the cutting bit slidably located within the guide cylinder;
a stop collar coupled to the shaft on a side of the shaft opposite from the chipper, the stop collar having a bottom spring surface;
a spring positioned around the shaft;
the spring positioned between the top spring surface of the guide cylinder and the bottom spring surface of the stop collar;
the spring configured to urge the cutting bit into a non-contact position.

34. The jig of claim 33, wherein the bit guide further comprises a bit guide base coupled to the base and a plurality of stanchions reaching from the bit guide base to the guide cylinder and defining an empty space; and
wherein the cutting bit is in the non-contact position when the chipper is at least partially within the empty space.

35. The jig of claim 33 wherein the base further comprises a bottom surface; and
wherein the cutting bit is in the non-contact position when the chipper is above the bottom surface of the base and not in contact with a workpiece.

36. The jig of claim 33 wherein the stop collar includes a pilot hole bit recess, the jig further comprising:
a pilot hole drill bit attachment having a pilot hole drill bit fitting, the pilot hole drill bit fitting removably contained within the pilot hole bit recess;
a pilot hole drill bit coupled to the pilot hole drill bit fitting.

37. The jig of claim 33, wherein the stop collar includes a pilot hole bit recess, the jig further comprising:
a pilot hole drill bit attachment having a pilot hole drill bit fitting, the pilot hole drill bit fitting removably contained within the pilot hole bit recess;
a pilot hole drill bit coupled to the pilot hole drill bit fitting and extending through the stop collar and into the shaft.

38. The jig of claim 33, wherein the cutting bit includes a pilot hole drill bit that is separable from the chipper.

39. The jig of claim 33 further comprising a pilot hole drill bit, wherein the pilot hole drill bit is configured to connect to the cutting bit and wherein the pilot hole drill bit is separable from the cutting bit.

40. The jig of claim 33, wherein the stop collar includes a pilot hole bit recess, the jig further comprising:
a pilot hole drill bit attachment having a pilot hole drill bit fitting, the pilot hole drill bit fitting removably contained within the pilot hole bit recess;
a pilot hole drill bit coupled to the pilot hole drill bit fitting and extending through the stop collar and into the shaft.

41. The jig of claim 33 further comprising:
a pair of edge knobs rotatably coupled to the base;
the edge knobs comprising edge location surfaces configured to set a centerline of the bit aperture a predetermined distance from an edge of the workpiece.

42. The jig of claim 33 wherein the stop collar includes a pilot hole bit recess, the jig further comprising:
a pilot hole drill bit attachment having a pilot hole drill bit fitting, the pilot hole drill bit fitting corresponding to and removably contained within the pilot hole bit recess;
a pilot hole drill bit coupled to the pilot hole drill bit fitting and extending through the stop collar and into the shaft.
